(19) United States
(12) Patent Application Publication
(10) Pub. No.: US 2020/0273637 A1
(43) Pub. Date: Aug. 27, 2020

(54) SWITCH AND METHOD FOR MANUFACTURING SAME

(71) Applicant: Fujikura Ltd., Tokyo (JP)

(72) Inventors: Yasuyuki Matsushima, Sakura-shi (JP); Yasuyuki Tachikawa, Sakura-shi (JP); Wataru Tanaka, Sakura-shi (JP)

(73) Assignee: Fujikura Ltd., Tokyo (JP)

(21) Appl. No.: 16/062,230

(22) PCT Filed: Dec. 21, 2016
(86) PCT No.: PCT/JP2016/088069

§ 371 Date: Jun. 14, 2018

(30) Foreign Application Priority Data
Dec. 21, 2015 (JP) 2015-248390

(51) Int. Cl. H01H 1/06; H01H 13/10; H01H 13/14; H01H 11/04

(52) U.S. Cl. CPC H01H 1/06; H01H 13/10; H01H 2233/07; H01H 11/04; H01H 13/14

(57) ABSTRACT

A membrane switch includes an upper electrode sheet that includes an upper electrode, a lower electrode sheet that includes a lower electrode facing the upper electrode, and an adhesive layer that joins the upper electrode sheet to the lower electrode sheet; and the upper and lower electrodes come into contact with each other due to a pressing force, which is applied to at least one of the upper electrode sheet and the lower electrode sheet, and conduct electricity. The upper electrode sheet includes: an upper base on which the upper electrode is formed; and an upper insulating layer that is provided between the upper base and the lower electrode sheet, includes a first opening at a position corresponding to the upper electrode, and is joined to the lower electrode sheet by the adhesive layer. The upper insulating layer is formed on the upper base.

### TECHNICAL FIELD

The present invention relates to a switch and a method for manufacturing the switch.

For designated nations where incorporation of a document by reference is admitted, the contents of Japanese Patent Application No. 2015-248390 filed on Dec. 21, 2015 are incorporated in this specification by reference and are regarded as a part of this specification.

### BACKGROUND ART

A switch, which includes upper and lower electrode sheets and a spacer provided between the upper and lower electrode sheets to form a desired interval between the upper and lower electrode sheets and in which the upper and lower electrode sheets are bonded to the spacer by adhesives, is known for example, see Patent Document 1). In the switch disclosed in Patent Document 1, an opening, which allows upper and lower electrodes to come into contact with each other, is formed at the spacer and the adhesives are provided around the opening of the spacer by printing or the like.

### CITATION LIST

### Patent Document

Patent Document 1: JP 2002-358852 A

### SUMMARY OF THE INVENTION

### Problem to be Solved by the Invention

In the switch, sagging may occur on the adhesives around the opening of the spacer in a case in which the adhesives are provided on the spacer by printing. In a case in which the electrode sheets are made thin for a reduction in the thickness of the switch, the stiffness of the electrode sheets is lowered. For this reason, in a case in which the electrode sheets are bonded to portions of the adhesives, at which sagging occurs, along the shapes of the portions of the adhesives at the time of an operation for pressing the switch, recesses may be formed at the contact portions of the electrode sheets. In this case, since the upper and lower electrodes are in a state in which the upper and lower electrodes approach each other, there is a possibility that the switch may be unintentionally turned on.

An object of the invention is to provide a switch in which a recess to he formed at a contact portion of an electrode sheet can be suppressed and a method for manufacturing the switch.

### Means for Solving Problem

[1] A switch according to the present invention comprising: a first electrode sheet that includes a first electrode; a second electrode sheet that includes a second electrode facing the first electrode; and an adhesive material that joins the first electrode sheet to the second electrode sheet, wherein the first and second electrodes come into contact with each other and conduct electricity due to a pressing force, which is applied to at least one of the first and second electrode sheets, and wherein the first electrode sheet includes: a first base on which the first electrode is formed; and a first spacer that is provided between the first base and the second electrode sheet, includes a first opening at a position corresponding to the first electrode, is joined to the second electrode sheet by the adhesive material, and is formed on the first base.

[2] In the above invention, the second electrode sheet may include: a second base on which the second electrode is formed; and a second spacer that is provided between the second base and the first spacer, it a second opening at a position corresponding to the second electrode, is joined to the first spacer by the adhesive material, and is formed on the second electrode sheet.

[3] In the above invention, the second electrode sheet may include a second base on which the second electrode is formed, and the first spacer may be joined to the second base by the adhesive material.

[4] In the above invention, the adhesive material may be positioned outside a peripheral edge of the first opening

[5] In the above invention, the stiffness of the first spacer may be higher than the stiffness of the adhesive material.

[6] In the invention, the first spacer may be thinner than the first base.

[7] In the invention, the first electrode sheet may include lead wires formed on the first base, and the first spacer may include an insulating cover portion that covers the lead wires.

[8] In the above invention, the lead wires may include: a first lead wire, and a second lead wire that includes a jumper portion at a position intersecting the first lead wire, wherein the cover portion includes jumper openings formed the cover portion so as to overlap a part of the second lead wire formed on the first base, and is interposed between the jumper portion and the first lead wire intersecting each other, and wherein the jumper portion includes: a pair of jumper connecting portions that is filled in the jumper openings and is connected to the second lead wire formed on the first base; and a jumper wire that is formed on the cover portion and connects the pair of jumper connecting portions.

[9] In the invention, the switch may further include an insulating jumper portion-insulating portion that is formed on the cover portion so as to cover the jumper portion.

[10] According to the present invention, there is provided a method for manufacturing a switch, the switch including: a first electrode sheet that includes a first electrode, a second electrode sheet that includes a second electrode facing the first electrode, and an adhesive material that joins the first electrode sheet to the second electrode sheet, the first and second electrodes coming into contact with each other and conducting electricity due to a pressing force, which is applied to the first electrode sheet or the second electrode sheet, wherein the method comprising: forming a first spacer, which includes an opening at a position corresponding to the first electrode, on a. first base on which the first electrode is formed; and joining the first spacer to the second electrode sheet by the adhesive material.

[11] In the above invention, the first spacer may be formed by the printing and curing of an insulating material, which forms the first spacer, on the first base.

### Effect of the Invention

According to the invention, since the first spacer is formed on the first base of the first electrode sheet, the first base of the first electrode sheet is reinforced. Accordingly, since it is possible to inhibit the first electrode sheet from being bonded along the shape of the adhesive, it is possible to suppress a recess that is to be formed at the contact portion of the first electrode sheet.

### BRIEF DESCRIPTION OF DRAWINGS

FIG. 1 is a cross-sectional view of a membrane switch according to first embodiment of the invention;

FIG. 2 is a plan view taken along line II-II of FIG. 1;

FIG. 3 is a cross-sectional view illustrating the state of the membrane switch according to the first embodiment of the invention at the time of a pressing operation;

FIG. 4 is a cross-sectional view illustrating the state of a membrane switch according to a comparative example at the time of a pressing operation;

FIG. 5 is a cross-sectional view illustrating the state of the membrane switch according to the comparative example at the time of a pressing operation;

FIG. 6 is a plan view of the membrane switch according to the first embodiment of the invention;

FIG. 7 is an exploded perspective view of the membrane switch according to the first embodiment of the invention;

FIG. 8 is a cross-sectional view taken along line VIII-VIII of a partially enlarged view of FIG. 6;

FIG. 9 is a flowchart illustrating a method for manufacturing the membrane switch to the first embodiment of the invention;

FIG. 10 is a cross-sectional view of a membrane switch according to a second embodiment of the invention;

FIG. 11 is a plan view of the membrane switch according to the second embodiment of the invention;

FIG. 12 is an exploded perspective view of the membrane switch according to the second embodiment of the invention;

FIG. 13 is a cross-sectional view taken along line XIII-XIII of a partially enlarged view of FIG. 11;

FIG. 14 is a flowchart illustrating a method for manufacturing the membrane switch according to the second embodiment of the invention;

FIG. 15 is a cross-sectional view of a membrane switch according to a third embodiment of the invention;

FIG. 16 is a plan view of the membrane switch according to the third embodiment of the invention;

FIG. 17 is an exploded perspective view of the membrane switch according to the third embodiment of the invention;

FIG. 18 is a cross-sectional view taken along line XVIII-XVIII of a partially enlarged view of FIG. 16; and

FIG. 19 is a flowchart illustrating a method for manufacturing the membrane switch according to the third embodiment of the invention.

### MODES FOR CARRYING OUT THE INVENTION

Embodiments of the invention will be described below with reference to the drawings.

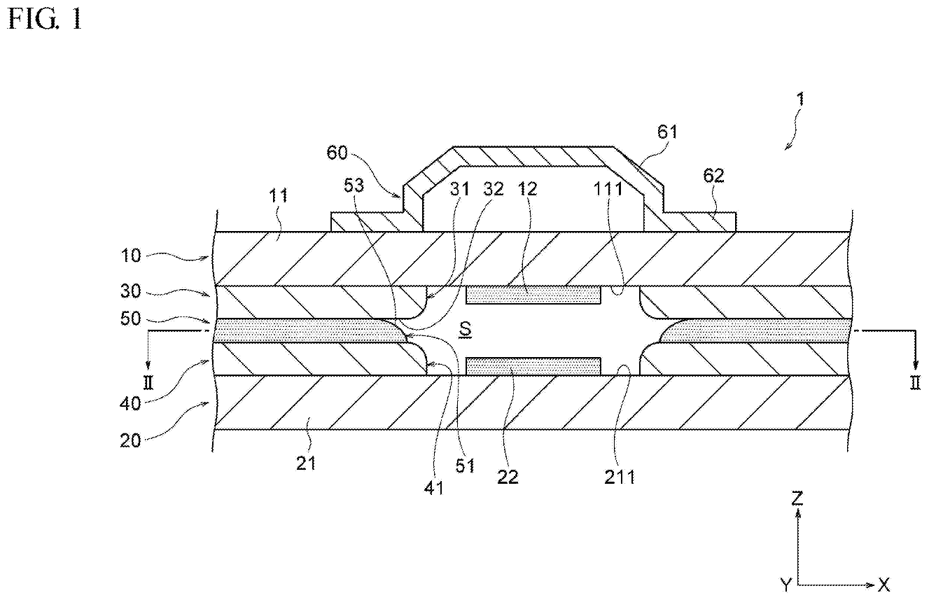

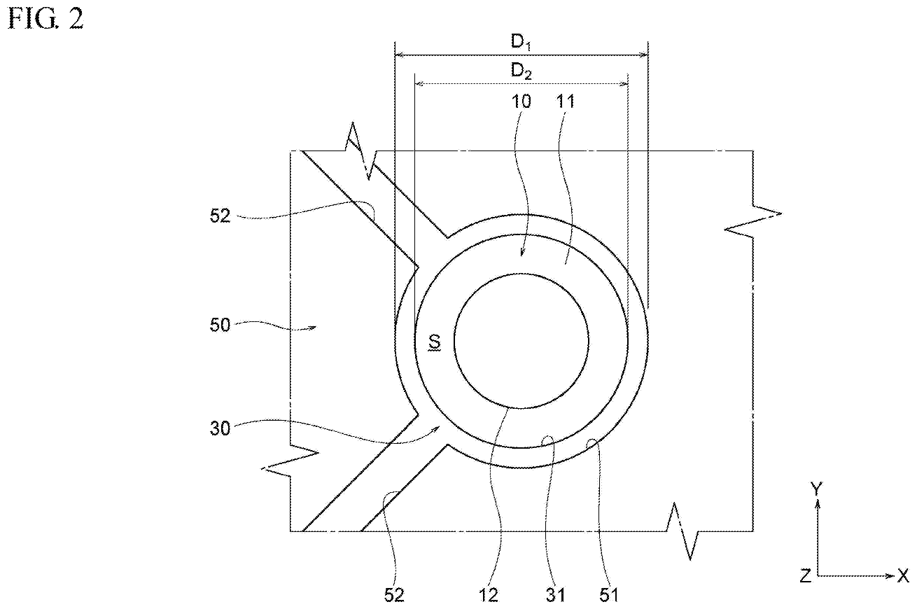

FIG. 1 is a cross-sectional view of a membrane switch 1 according to a first embodiment of the invention, and FIG. 2 is a plan view taken along line II-II of FIG. 1.

As illustrated m FIGS. 1 and 2, the membrane switch 1 of this embodiment includes an upper electrode sheet 10, a lower electrode sheet 20, an adhesive layer 50, and a rubber dome 60. The rubber dome 60 is a pressing member. The upper electrode sheet 10 includes an upper base 11, an upper electrode 12, and an upper insulating layer 30. Further, the lower electrode sheet 20 includes a lower base 21, a lower electrode 22, and a lower insulating layer 40. In the membrane switch 1, an upper insulating layer 30 is formed on a lower surface 111 of the upper base 11 of the upper electrode sheet 10, the lower insulating layer 40 is formed on an upper surface 211 of the lower base 2.1 of the lower electrode sheet 20, and the upper and lower insulating layers 30 and 40 are joined to each other by the adhesive layer 50. Further, the rubber dome 60 is mounted on the upper surface of the upper base 11 of the upper electrode sheet 10.

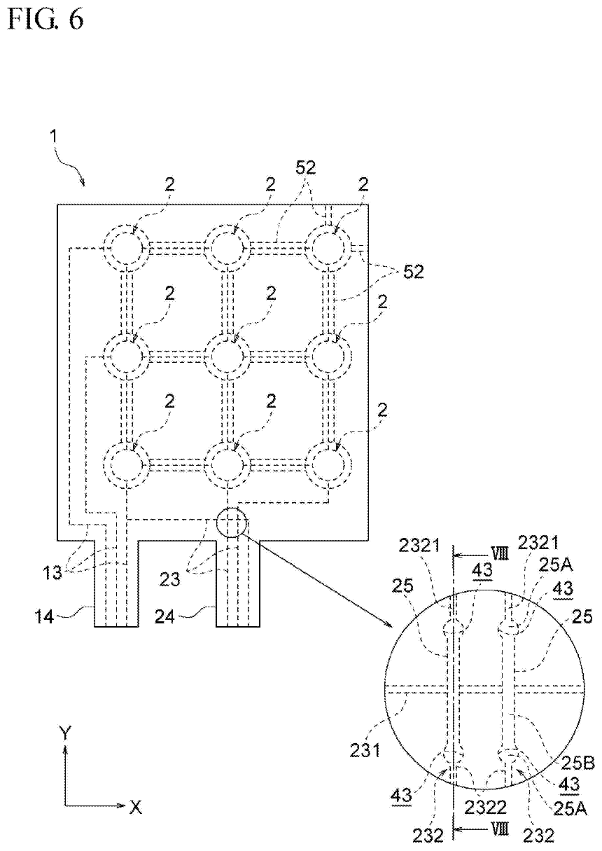

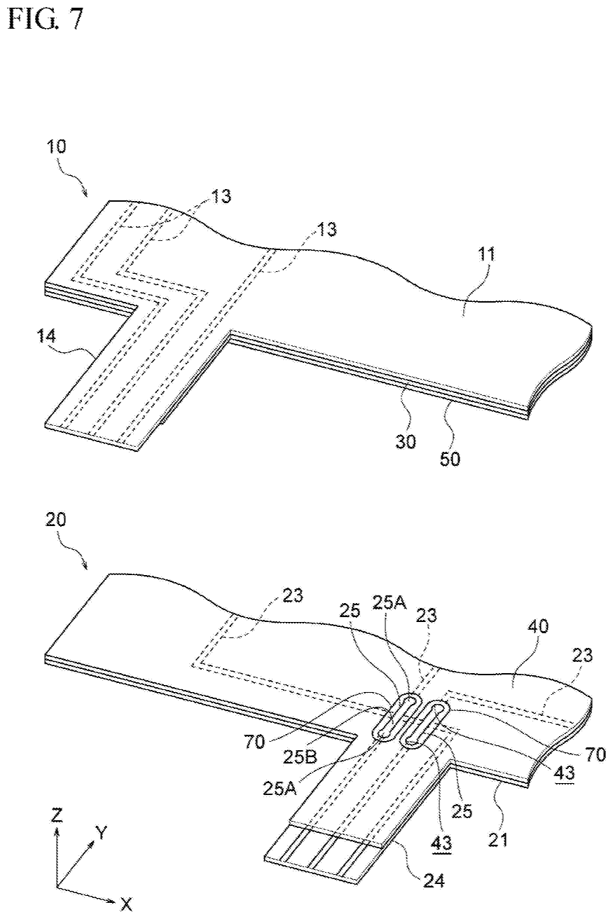

In the membrane switch 1, a predetermined pressing force is applied to the upper electrode sheet 10 through the rubber dome 60 by an operator, so that the upper and lower electrodes 12 and 22 (all of them will be described later) come into contact with each other and conduct electricity. The upper and lower electrodes 12 and 22 are connected to an external circuit through lead wires 13 and 23 (see FIGS. 6 and 7), and the external circuit detects an operator's pressing operation through electrical conduction between the upper and lower electrodes 12 and 22. In this embodiment, a pressing force, which is applied when the external circuit detects an operator's pressing operation, is referred to as an “ON-load”.

The detection of an operator's pressing operation, which is performed using the membrane switch 1, is not particularly limited to the above-mentioned detection. For example, an operator's pressing operation may be detected on the basis of a circuit resistance value that increases or decreases with a change in the contact area (contact state) between the upper and lower electrodes 12 and 22 according to a pressing force. The “membrane switch 1” of this embodiment corresponds to an example of a “switch” of the invention.

The upper base 11 of the upper electrode sheet 10 is made of, for example, a flexible insulating material, such as polyethylene terephthalate or polyethylene naphthalate. In terms of reducing the thickness of the membrane switch 1, the thickness of the upper base 11 is set in the range of 20 to 100 μm and is preferably set in the range of 20 to 75 μm. In this embodiment, the thickness of the upper base 11 is set to 50 μm.

The upper electrode 12 is formed by the printing and curing of conductive paste, such as silver paste, copper paste, or carbon paste, on the lower surface 111 of the upper base 11. The upper electrode 12 may be formed of a plurality of layers. Screen printing, gravure offset printing, inkjet printing, and the like can be exemplified as a printing method of forming the upper electrode 12.

Although not particularly illustrated, the upper electrode 12 is connected to the external circuit through the lead wires 13 (see FIGS. 6 and 7). In this case, the upper electrode 12 and the lead wires 13 may be formed integrally with each other, and may be formed separately from each other.

The upper electrode 12 has a circular outer shape having a diameter smaller than the diameter of each of openings 31 and 41, which will be described later, of the upper and lower insulating layers 30 and 40. Further, the upper electrode 12 is provided at a position corresponding to the upper and lower openings 31 and 41. Specifically, the center of the upper electrode 12 substantially coincides with the centers of the upper and lower openings 31 and 41.

Meanwhile, the “center” means a point corresponding to the centroid of a planar shape in this specification. Incidentally, the shape of the upper electrode 12 is not particularly limited to the above-mentioned shape. For example, the outer shape of the upper electrode 12 may be a rectangular shape, a mesh shape, a comb shape, or the like.

The “upper electrode sheet 10” of this embodiment corresponds to an example of a “first electrode sheet” of the invention, the “upper base 11” of this embodiment corresponds to an example of a “first base” of the invention, and the “upper electrode 12” of this embodiment corresponds to an example of a “first electrode” of the invention.

The lower base 21 of the lower electrode sheet 20 is made of a flexible insulating material, such as polyethylene terephthalate or polyethylene naphthalate, as in the case of the upper base 11. In terms of reducing the thickness of the membrane switch 1, the thickness of the lower base 21 is set in the range of 20 to 100 μm and is preferably set in the range of 20 to 75 μm. Ira this embodiment, the thickness of the lower base 21 is set to 50 μm.

As in the case of the upper electrode 12, the lower electrode 22 is formed by the printing and curing of conductive paste, such as silver paste, copper paste, or carbon paste, on the upper surface 211 of the lower base 21. Meanwhile, the lower electrode 22 may also be formed of a plurality of layers. The same method as the above-mentioned method of forming the upper electrode 12 can be exemplified as a method of forming the lower electrode 22.

As in the case of the upper electrode 12, the lower electrode 22 is connected to the external circuit through the lead wires 23 (see FIGS. 6 and 7). The lower electrode 22 and the lead wires 23 may be formed integrally with each other, and may be formed separately from each other.

The lower electrode 22 has a circular outer shape having a diameter smaller than the diameter of each of the openings 31 and 41, which will be described later, of the upper and lower insulating layers 30 and 40. The lower electrode 22 is provided at a position facing the upper electrode 12 through an interior space S. Specifically, the center of the lower electrode 22 substantially coincides with the center of the upper electrode 12. Meanwhile, the shape of the lower electrode 22 is not particularly limited to the above-mentioned shape. For example, the outer shape of the lower electrode 22 may be a rectangular shape, a mesh shape, a comb shape, or the like.

The “lower electrode sheet 20” of this embodiment corresponds to an example of a “second electrode sheet” of the invention, the “lower base 21” of this embodiment corresponds to an example of a “second base” of the invention, and the “lower electrode 22” of this embodiment corresponds to an example of a “second electrode” of the invention.

The upper insulating layer 30 is formed by the printing and curing of a resist material on the lower surface 111 of the upper base 11. The resist material is a UV curable resin or a thermosetting resin, such as an epoxy resin a methane resin, a polyester resin, or an acrylic resin. Screen printing, gravure offset printing, inkjet printing, and the like can be exemplified as a printing method of forming the upper insulating by 30. In terms is of reducing the thickness of the membrane switch 1 and increasing the stiffness of the membrane switch 1, the thickness, of the upper insulating layer 30 is set in the range of 0.5 to 50 μm and is preferably set in the range of 10 to 30 μm. In this embodiment, the thickness of the upper insulating layer 30 is set to 15 μm and is set to be smaller than the thickness of the upper base 11. In this embodiment, in terms of improving the accuracy of the thickness of the upper insulating layer 30, a UV curable resin is used as the resist material and the UV curable resin printed on the lower surface 111 of the upper base 11 is cured by UV curing treatment to form the upper insulating layer 30.

The stiffness of the upper insulating layer 30 is set to be higher than the stiffness of the adhesive layer 50. In this specification, the “stiffness” of the upper base 11 or the upper insulating layer 30 means the degree of difficulty in deforming the upper base 11 or the upper insulating layer 30 against a force that is applied in the thickness direction of the upper base 11 or the upper insulating layer 30.

A circular first opening 31, which has a diameter larger than the diameter of each of the upper and lower electrodes 12 and 22, is formed at the upper insulating layer 30. The first opening 31 is provided so as to surround the upper electrode 12. Specifically, the center of the upper electrode 12 substantially coincides with the center of the first opening 31. The diameter of the first opening 31 is not particularly limited. However, in terms of stabilizing the ON-load of the membrane switch 1, it is preferable that the diameter of the first opening 31 is 5 mm or less. In this regard, for the prevention of the excessive increase of the ON-load, it is preferable that the diameter of the first opening 31 is 1 mm or more.

The shape of the first opening 31 is not limited to a circular shape, and may be, for example, a rectangular shape, or the like. The “upper insulating layer 30” of this embodiment corresponds to an example of a “first spacer” of the invention, and the “first opening 31” of this embodiment corresponds to an example of a “first opening” of the invention.

The lower insulating layer 40 is formed by the printing and curing of a resist material on the upper surface 211 of the lower base 21. The resist material is a UV curable resin or a thermosetting resin, such as an epoxy resin, a urethane resin, a polyester resin, or an acrylic resin. As in the case of the upper insulating layer 30, screen printing, gravure offset printing, inkjet printing, and the like can be exemplified as a printing method of forming the lower insulating layer 40. In terms of reducing the thickness of the membrane switch 1 and increasing the stiffness of the membrane switch 1, the thickness of the lower insulating layer 40 is set in the range of 5 to 50 μm and is preferably set in the range of 10 to 30 μm. In this embodiment, the thickness of the lower insulating layer 40 is set to 15 μm and is set to be smaller than the thickness of the lower base 21. In this embodiment, in terms of improving the accuracy of the thickness of the lower insulating layer 40, a UV curable resin is used as the resist material and the UV curable resin printed on the upper surface 211 of the lower base 21 is cured by UV curing treatment to form the lower insulating layer 40.

The stiffness of the lower insulating layer 40 is set to be higher than the stiffness of the adhesive layer 50. Meanwhile, in this specification, the “stiffness” of the lower base 21 or the lower insulating layer 40 means the degree of difficulty in deforming the lower base 21 or the lower insulating layer 40 against a force that is applied in the thickness direction of the lower base 21 or the lower insulating layer 40.

A circular second opening 41, which has a diameter larger than the diameter of each of the upper and lower electrodes 12 and 22, is formed at the lower insulating layer 40. The second opening 41 is provided so as to surround the lower electrode 22. Specifically, the center of the lower electrode 22 substantially coincides with the center of the second opening 41. The diameter of the second opening 41 is not particularly limited. However, in terms of stabilizing the ON-load of the membrane switch 1, it is preferable that the diameter of the second opening 41 is 5 mm or less. In this regard, for the prevention of the excessive increase of the ON-load, it is preferable that the diameter of the second opening 41 is 1 mm or more.

Meanwhile, the shape of the second opening 41 is not limited to a circular shape, and may be, for example, a rectangular shape, or the like. The “lower insulating layer 40” of this embodiment corresponds to an example of a “second spacer” of the invention, and the “second opening 41” of this embodiment corresponds to an example of a “second opening” of the invention.

The adhesive layer 50 is interposed between the upper, and lower insulating layers 30 and 40, and has a function to allow the upper and lower insulating layers 30 and 40 to adhere (bond) to each other. It is preferable that the adhesive layer 50 contains a resin material, and the adhesive layer 50 may further contain additives and the like. The resin material, which forms the adhesive layer 50, can be properly selected and used according to the pressure sensitivity of the membrane switch 1. For example, a thermoplastic resin, a thermosetting resin, and the like can be exemplified as the resin material. In terms of reducing the thickness of the membrane switch 1, the thickness of the adhesive layer 50 is set in the range of 5 to 50 μm and is preferably set in the range of 10 to 30 μm. In this embodiment, the thickness of the adhesive layer 50 is set to 15 μm.

Meanwhile, a polyvinyl acetate resin, polyvinyl alcohol, polyvinyl acetal, an ethylene-vinyl acetate (EVA) resin, a vinyl chloride resin, an acrylic resin, a polyamide resin, an α-olefin resin, and the like can be exemplified as the thermoplastic resin. A urea resin, a melamine resin, a phenolic resin, a resorcinol resin, an epoxy resin, a urethane resin, and the like can be exemplified as the thermosetting resin.

The adhesive layer 50 of this embodiment includes a third opening 51 and air vents 52. The adhesive layer 50 is uniformly formed between the upper and lower insulating layers 30 and 40 over substantially the entire surface of the upper and lower insulating layers 30 and 40 except for the third opening 51 and the air vents 52.

The third opening 51 has a circular outer shape so as to correspond to the upper and lower electrodes 12 and 22. The third opening 51 is a through-hole that passes through the adhesive layer 50 in a vertical direction (Z direction) and is opened to both principal surfaces of the adhesive layer 50.

The third opening 51 is provided at a position corresponding to the upper and lower electrodes 12 and 22. Specifically, the centers of the upper and lower electrodes 12 and 22 substantially coincide with the center of the third opening 51. As a result, the center of the first opening 31 the center of the second opening 41, and the center of the third opening 51 substantially coincide with each other in this embodiment.

The air vents 52 are formed between the upper and lower insulating layers 30 and 40. The air vents 52 are through-holes allowing the interior space S (specifically, the third opening 51), which is provided around the upper and lower electrodes 12 and 22, to communicate with an exterior space.

In this embodiment, the intake and discharge of air present in the interior space S according to an operator's pressing operation are performed through the air vents 52. That is, air present in the interior space S is discharged from the air vents 52 in a case in which a pressing force is applied by an operator, and air is taken in to the interior space S from the air vents 52 in a case in which the pressing force applied by the operator is released. The interior space S may not be sealed as described above so that a sense of incongruity is not given to an operator.

The adhesive layer 50 is not particularly limited. However, for example, the adhesive layer 50 can be formed by the application, drying, and the like of an adhesive material, which forms the adhesive layer 50, on the lower insulating layer 40 using a publicly known method, such as gravure coating, roll coating, screen printing, gravure offset printing, or inkjet printing, in this embodiment, the adhesive layer 50 is formed using a printing technique, such as screen printing. Meanwhile, in this embodiment, after the adhesive layer 50 is formed on the lower insulating layer 40, the upper insulating layer 30 is placed on the adhesive layer 50 and the upper and lower insulating layers 30 and 40 between which the adhesive layer 50 is interposed are bonded to each other by laminating However, this is not essential. After the adhesive layer 50 may be formed on the upper insulating layer 30, the lower insulating layer 40 may be placed on the adhesive layer 50 and the upper and lower insulating layers 30 and 40 between which the adhesive layer 50 is interposed may be bonded to each other by laminating.

Meanwhile, the third opening 51 and the air vents 52 may be formed by the patterning that is performed after a mask is stacked on one of the upper and lower insulating layers 30 and 40, or the third opening 51 and the air vents 52 may be formed by the partial scraping of an adhesive material after the adhesive material is applied to the entire surface of one of the upper and lower insulating layers 30 and 40. Alternatively, the third opening 51 and the air vents 52 may be formed by the selective application of an adhesive material.

In this embodiment, in terms of suppressing the deterioration of switching performance that is caused in a case in which the upper and lower electrode sheets 10 and 20 are unintentionally bonded to each other, the outer shape of the third opening 51 is adapted to be larger than the outer shape of each of the first and second openings 31 and 41. Specifically, the diameter D1 of the third opening 51 is adapted to be larger than the diameter D2 of each of the first and second openings 31 and 41 as illustrated in FIG. 2. Particularly, in this embodiment, the diameter D1 of the third opening 51 is adapted to be larger than the diameter D2 of each of the first and second openings 31 and 41 by 0.4 to 1.0 mm. Here, since a variation occurs in the ON-load in a case in which a difference between the diameters D1 and D2 is smaller than 0.4 mm or is larger than 1.0 mm, the adhesive layer 50 cannot fulfill a function required as an adhesive layer. Meanwhile, the diameter D1 of the third opening 51 may be equal to or larger than the diameter D2 of each of the first and second openings 31 and 41. Further, the shape of the third opening 51 is not particularly limited to the above-mentioned shape. For example, the third opening 51 may have a rectangular shape or the like.

The total thickness of the upper insulating layer 30, the adhesive layer 50, and the lower insulating layer 40 is set to be smaller than the thickness of the upper base 11 or the lower base 21. The “adhessive layer 50” of this embodiment corresponds to an example of an “adhesive” of the invention, and the “third opening 51” of this embodiment corresponds to an example of a “third opening” of the invention.

As illustrated in FIG. 1, the rubber dome 60 is mounted on the upper surface of the upper base 11 of the upper electrode sheet 10. The rubber dome 60 is an elastic member that is made of a rubber material or the like and is provided to allow a key top, which is provided so as to be movable in the vertical direction of the rubber dome 60, to return to an initial position when a pressing force is transmitted to the rubber dome 60 through the key top.

The rubber dome 60 includes a dome-shaped body portion 61 that protrudes toward a side where the rubber dome 60 is separated from the upper base 11 of the upper electrode sheet 10, and a mounting portion 62 that extends outward from the edge portion of the body portion 61.

Meanwhile, the rubber dome 60 is directly mounted on the upper surface of the upper base 11 of the upper electrode sheet 10 in this embodiment, but is not particularly limited thereto. For example, a rubber dome-support member (not illustrated) made of PET or the like may be provided on the upper surface of the upper base 11 of the upper electrode sheet 10, and the rubber dome 60 may be mounted on the upper base 11 of the upper electrode sheet 10 through the cover member. Further, the rubber dome 60 has a function a pressing member that assists an operation for pressing the membrane switch 1. The pressing member is not limited to the rubber dome, and may be a metal dome or a protrusion that is provided on the, lower surface of the key top. Furthermore, it is not essential that the pressing member is provided.

The mounting portion 62 is an annular member that is formed over the entire circumference of the body portion 61, and is in close contact with the upper surface of the upper base 11 of the upper electrode sheet 10. The outer shape of the body portion 61 and the outer shape of the mounting portion 62 are a circular shape in plan view. Further, the rubber dome 60 is formed so that the center (apex) of the body portion 61 and the center of the mounting portion 62 substantially coincide with each other.

Incidentally, when the adhesive layer 50 is formed, sagging occurs at an edge portion 53 of the adhesive layer 50 as illustrated in FIG. 1 since the adhesive material has flowability. An edge portion 32 of the upper insulating layer 30 faces the edge portion 53 with a gap therebetween. Here, the first upper base 11 and the upper insulating layer 30 are integrated with each other, so that the upper base 11 is reinforced by the upper insulating layer 30. Acccordingly, the stiffness of a portion of the upper base 11 on which the upper insulating layer 30 is provided is higher than the stiffness of a portion of the upper base 11 on which the upper electrode 12 is provided, and it is more difficult for the portion of the upper base 11 on which the upper insulating layer 30 is provided to be bent than the portion of the upper base 11 on which the upper electrode 12 is provided.

In a case in which the edge portion 32 of the upper insulating layer 30 comes into contact with the edge portion 53 of the adhesive layer 50 due to an excessive pressing force that is applied to the upper base 11 through the rubber dome 60, the adhesive force of the edge portion 53 of the adhesive layer 50 acts on the edge portion 32 of the upper insulating layer 30 and resists the restoring force of the upper base 11 and the upper insulating layer 30 that is generated from an elastically deformed state. In a case in which the adhesive force of the edge portion 53 of the adhesive layer 50 exceeds the restoring force of the upper base 11 and the upper insulating layer 30, the upper base 11 and the upper insulating layer 30 are maintained in a recessed state.

Accordingly, in this embodiment, even though the edge portion 32 of the upper insulating layer 30 and the edge portion 53 of the adhesive layer 50 come into contact with each other due to an excessive pressing force that is applied to the upper base 11 through the rubber dome 60, the stiffness of an integrated object in which the upper base 11 and the upper insulating layer 30 are integrated with each other is set so that the restoring force of the upper base 11 and the upper insulating layer 30 generated from an elastically deformed state exceeds the adhesive force of the adhesive layer 50.

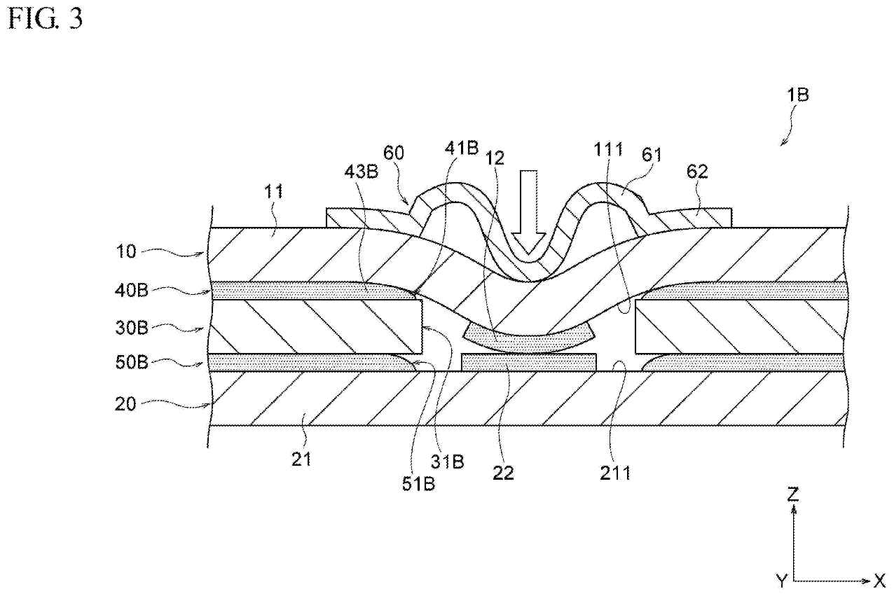

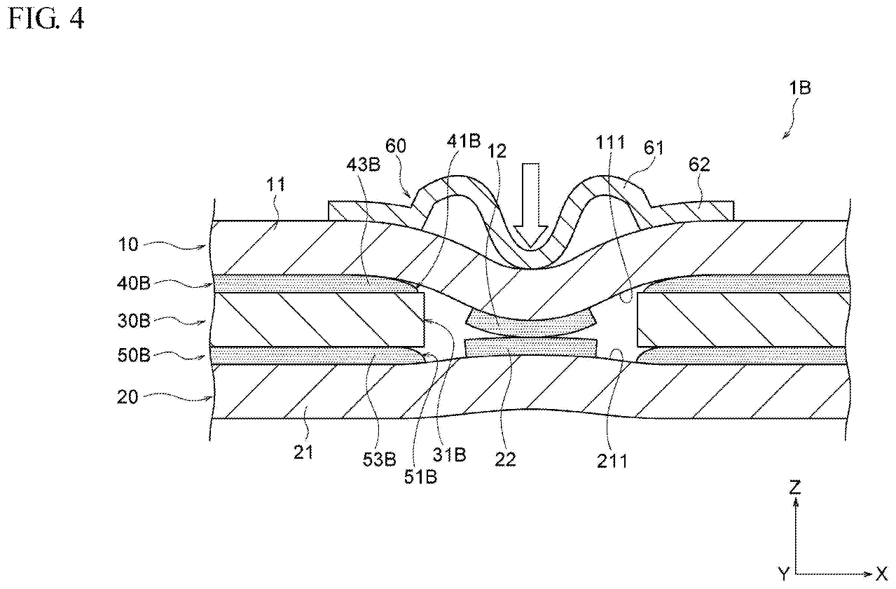

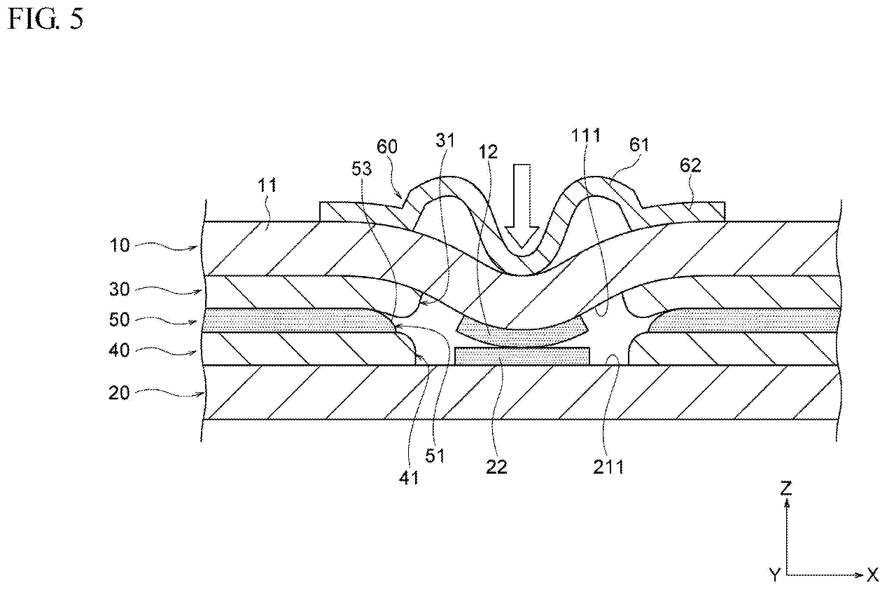

FIGS. 3 and 4 are cross-sectional views illustrating the state of a membrane switch 1B according to a comparative example at the time of a pressing operation. Further, FIG. 5 is a cross-sectional view illustrating the state of the membrane switch 1 according to the first embodiment at the time of a pressing operation. Meanwhile, in the description of the comparative example, the same components as those of the first embodiment are denoted by the same reference numerals as those of the first embodiment and the description of the first embodiment will be quoted.

As illustrated in FIGS. 3 and 4, the membrane switch 1B according to the comparative example includes an upper electrode sheet 10, a lower electrode sheet 20, a spacer 30B, an upper adhesive layer 40B, a lower adhesive layer 50B, and a rubber dome 60. In the membrane switch 1B, the spacer 30B is provided between the upper and lower electrode sheets 10 and 20, the upper surface of the spacer 30B and the lower surface of the upper electrode sheet 10 adhere to each other by the upper adhesive layer 40B, and the lower surface of the spacer 30B and the upper surface of the lower electrode sheet 20 adhere to each other by the lower adhesive layer 50B.

The spacer 30B is a PET film. A first opening 31B is formed at the spacer 30B so as to correspond to the upper and lower electrodes 12 and 22. Further, a second opening 41B is formed at the upper adhesive layer 40B so as to correspond to the upper and lower electrodes 12 and 22, and a third opening 51B is formed at the lower adhesive layer 50B so as to correspond to the upper and lower electrodes 12 and 22. Here, the peripheral edge portion of the second opening 41B is positioned outside the peripheral edge portion of the first opening 31B. Furthermore, the peripheral edge portion of the third opening 51B is also positioned outside the peripheral edge portion of the first opening 31B.

Here, sagging occurs at an edge portion 43B of the upper adhesive layer 40B. An upper base 11 of the upper electrode sheet 10 faces the edge portion 43B with a gap therebetween. For this reason, when a pressing force is applied to the upper base 11 through the rubber dome 60 and the upper base 11 is recessed, the upper base 11 approaches the edge portion 43B of the adhesive layer 40B. Then, in a case in which the upper base 11 comes into contact with the edge portion 43B of the upper adhesive layer 40B, the adhesive force of the edge portion 43B of the upper adhesive layer 40B acts on the upper base 1 and resists the restoring force of the upper base 11 that generated from an elastically deformed state.

Meanwhile sagging also occurs at an edge portion 53B of the lower adhesive layer 50B. The lower base 21 of the lower electrode sheet 20 faces the edge portion 53B with a gap therebetween. Here, when the lower electrode sheet 20 is not firmly fixed to a device, such as a keyboard device, in a state in which the membrane switch 1 is mounted on the device, not only the upper electrode sheet 10 to which a pressing force is to be applied but also the lower electrode sheet 20 is deformed while following the upper electrode sheet 10. In this case, the edge portion 53B of the lower adhesive layer 50B approaches the spacer 30B as illustrated in FIG. 4. Then, when the edge portion 53B of the lower adhesive layer 50B and the spacer 30B come into contact with each other the adhesive force of the edge portion 53B of the lower adhesive layer 50B resists the restoring force of the lower base 21 that is generated from an elastically deformed state.

Here, in the membrane switch 1B according to the comparative example, for the reduction of thickness, the thickness of the upper base 11 of the upper electrode sheet 10 and the thickness of the lower base 21 of the lower electrode sheet 20 are set to be small (for example, 50 as in this embodiment). For this reason, the stiffness of the upper base 11 and the stiffness of the lower base are low. Accordingly, when a pressing force is applied to the upper base 11 through the rubber dome 60, a portion of the upper base 11 facing the edge portion 43B of the upper adhesive layer 40B is easily bent and easily comes into contact with the edge portion 43B. On the other hand, when the lower base 21 is not firmly fixed to a device, such as a keyboard device on which the membrane switch 1B is to be mounted, a portion of the lower base 21 corresponding to the edge portion 53B of the lower adhesive layer 50B is easily bent while following the upper base 11 as illustrated in FIG. 4. Accordingly, the edge portion 43B easily comes into contact with the spacer 30B. In addition, since the adhesive force of the edge portion 43B of the upper adhesive layer 40B exceeds the restoring force of the upper base 11 generated from an elastically deformed state, a state in which the upper base 11 is bonded along the shape of the edge portion 43B of the upper adhesive layer 40B, that is, a state in which the contact portion of the upper electrode sheet 10 is recessed is maintained.

In contrast, in the membrane switch 1 according to this embodiment, the upper insulating layer 30 is formed around the upper electrode 12 provided on the lower surface 111 of the upper base 11 and the upper base 11 and the upper insulating layer 30 are integrated with each other around the upper electrode 12 as illustrated in FIG. 5, so that the upper base 11 is reinforced by the upper insulating layer 30. Accordingly, when a pressing force is applied to the upper base 11 through the rubber dome 60, a portion of the upper base 11 on which the upper electrode 12 is provided is recessed but it is difficult for the portion where the upper base 11 and the upper insulating layer 30 are integrated with each other to be bent. Therefore, it is difficult for the portion where the upper base 11 and the upper insulating layer 30 are integrated with each other to approach the edge portion 53 of the adhesive layer 50. On the other hand, since the lower insulating layer 40 is formed around the lower electrode 22 provided on the upper surface 211 of the lower base 21 and the lower base 21 and the lower insulating layer 40 are integrated with each other around the lower electrode 22, the lower base 21 is reinforced by the lower insulating layer 40. Accordingly, even though the lower base 21 is not firmly fixed to a device, such as a keyboard device on which the membrane switch 1 is to be mounted, it is difficult for the portion where the lower base 21 and the lower insulating layer 40 are integrated with each other to be bent while following the upper base 11 when a pressing force is applied to the upper base 11 through the rubber dome 60. In addition the stiffness of an integrated object in which the upper base 11 and the upper insulating layer 30 are integrated with each other is set so that the restoring force of the upper base 11 and the upper insulating layer 30 generated from an elastically deformed state exceeds the adhesive force of the adhesive layer 50. For this reason, even though the edge portion 32 of the upper insulating layer 30 comes into contact with the edge portion 53 of the adhesive layer 50 due to an excessive pressing force that is applied to the upper base 11 through the rubber dome 60, the upper base 11 and the upper insulating layer 30 are restored from an elastically deformed state, that is, a recessed state. Accordingly, since it is possible to prevent a state in which the upper base 11 is bonded along the shape of the edge portion 53 of the adhesive layer 50, that is, a state in which the upper electrode sheet 10 is recessed from being maintained after an operation for pressing the membrane switch 1, it is possible to prevent an ON state from being maintained.

Further, the membrane switch 1 according to this embodiment can be made thinner than the membrane switch 1B according to the comparative example. That is, in this embodiment, the upper insulating layer 30 is formed by the printing and curing of a resist material on the upper electrode sheet 10 and the lower insulating layer 40 is formed by the printing and curing of a resist material on the lower electrode sheet 20. Here, since the upper and lower insulating layers 30 and 40 are formed by the printing and curing of a resist material, the upper and lower insulating layers 30 and 40 can be made thinner than the spacer 30B of the comparative example that is formed of a PET film. Furthermore, one adhesive layer 50 is formed in this embodiment, but the upper and lower adhesive layers 40B and 50B are formed in the comparative example. Accordingly, the thickness of an adhesive of this embodiment can be made smaller than that of the comparative example. As described above, the membrane switch 1 according to this embodiment can be made thinner than the membrane switch 1B according to the comparative example. Particularly, in a case in which the total thickness of the upper insulating layer 30 the adhesive layer 50, and the lower insulating layer 40 is set to be smaller than the thickness of the upper base 11 or the lower base 21 in this embodiment, it is possible to reduce the thickness of the membrane switch 1 and to suppress a recess that is to be formed at the contact portion of the upper electrode sheet 10 or the lower electrode sheet 20.

FIG. 6 is a plan view of the membrane switch 1 according to this embodiment. Further, FIG. 7 is an exploded perspective view of the membrane switch 1 according to this embodiment. As illustrated in FIGS. 6 and 7, the membrane switch 1 includes a plurality of electrode pairs 2, each of which includes the upper electrode 12 and the lower electrode 22. Furthermore, the membrane switch 1 includes a plurality of upper lead wires 13 that are provided on the upper base 11 of the upper electrode sheet 10, a plurality of lead wires 23 that are provided on the lower base 21 of the lower electrode sheet 20, an upper tail portion 14 that is provided on one side of the upper base 11, and a lower tail portion 24 that is provided on one side of the lower base 21.

The upper lead wires 13 are connected to the plurality of upper electrodes 12 arranged in a line, and are provided so as to extend to the end of the upper tail portion 14. The plurality of lead wires 13 are provided not to intersect each other. For this reason, the lead wires 13 do not include jumper portions. Meanwhile, the lower lead wires 23 are connected to the plurality of lower electrodes 22 arranged in a line, and are provided so as to extend to the end of the lower tail portion 24. Here, the plurality of lead wires 23 are provided so that two lead wires 23 intersect another lead wire 23. For this reason, as illustrated in a partially enlarged view of FIG. 6, jumper portions 25 are provided at two intersections here two lead wires 23 intersect another lead wire 23. The detailed structure of the jumper portion 25 will be described later. Meanwhile, “another lead wire 23” corresponds to a “first lead wire” of the invention and “two lead wires 23” correspond to a “second lead wire” of the invention.

The upper lead wires 13 are formed by the printing and curing of conductive paste, such as silver paste, copper paste, or carbon paste, on the lower surface 111 of the upper base 11 and the lower surface of the upper tail portion 14. Likewise, the lower lead wires 23 are formed by the printing and curing of conductive paste, such as silver paste, copper paste, or carbon paste, on the upper surface 211 of the lower base 21 and the upper surface of the lower tail portion 24.

Here, the upper insulating layer 30 is directly and integrally formed on the upper base 11, and is formed so as to cover the upper lead wires 13. In this embodiment, the lead wires 13 provided on the upper base 11 are covered with the upper insulating layer 30 except for a position facing the first opening 31. Meanwhile, the lead wires 13 provided on the upper tail portion 14 may be covered with the upper insulating layer 30, and may be covered with another insulating layer that is formed on the upper tail portion 14 separately from the upper insulating layer 30. Further, it is not essential that the lead wires 13 provided on the upper base 11 are covered with the upper insulating layer 30 over the entire area of the upper base 11, and a part of the lead wires 13 provided on the upper base 11 may be covered with another insulating material.

The lower insulating layer 40 is directly and integrally formed on the lower base 21, and is formed so as to cover the lower lead wires 23. In this embodiment, the lead wires 23 provided on the lower base 21 are covered with the lower insulating layer 40 except for a position facing the second opening 41. The lead wires 23 provided on the lower tail portion 24 may be covered with the lower insulating layer 40, and may be covered with another insulating layer that is formed on the lower tail portion 24 separately from the lower insulating layer 40. Further, it is not essential that the lead wires 23 provided on the lower base 21 are covered with the lower insulating layer 40 over the entire area of the lower base 21, and a part of the lead wires 23 provided on the lower base 21 may be covered with another insulating material.

The adhesive layer 50 includes a plurality of third openings 51 and air vents 52 that allow the third openings 51 to communicate with each other. The air vents 52 are provided between the plurality of third openings 51 that are arranged in a line. Furthermore, one air vent 52 is provided between one third opening 51 and one side of the adhesive layer 50, and allows the third opening 51 to communicate with the outside of the adhesive layer 50.

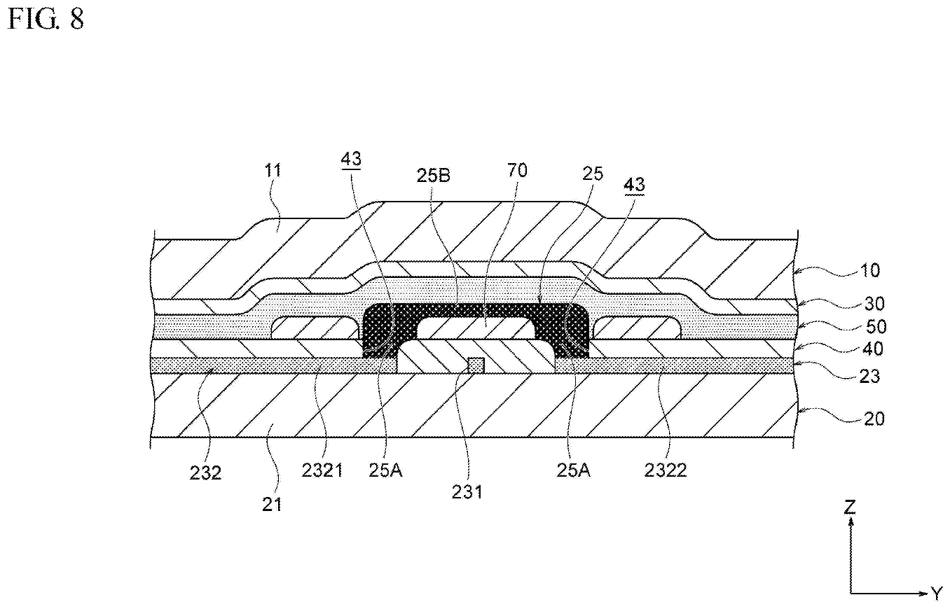

FIG. 8 is a cross-sectional view taken along line VIII-VIII of the partially enlarged view of FIG. 6. As illustrated in FIGS. 6 to 8, one lead wire 23 includes a straight portion 231 extending along one side of the lower base 21, and the other two lead wires 23 include straight portions 232 intersecting the straight portion 231. The straight portion 232 is divided into a first straight portion 2321 and a second straight portion 2322 not so as to intersect the straight portion 231 on the lower base 21. An end portion of the first straight portion 2321 and an, end portion of the second straight portion 2322 are connected to each other by the jumper portion 25.

The lower insulating layer 40 includes jumper openings 43 that are formed at positions facing the end portions of the first and second straight portions 2321 and 2322, respectively. A part of the first and second straight portions 2321 and 2322 overlap the jumper openings 43 and are exposed from the lower insulating layer 40. The jumper portion 25 includes a pair of jumper connecting portions 25A that is filled in the jumper openings 43, respectively, and a jumper wiring portion 25B that connects the pair of jumper connecting portions 25A. The jumper connecting portion 25A is connected to the end portion of the first straight portion 2321 or the end portion of the second straight portion 2322 in the jumper opening 43. Here, jumper portion-insulating layers 70 are formed on the lower insulating layer 40 only at the positions of the jumper portions 25. The jumper wiring portions 25B are formed on the jumper portion-insulating layers 70. The “jumper portion 25” of this embodiment corresponds to an example of a “jumper portion” of the invention, the “jumper connecting portion 25A” of this embodiment corresponds to an example of a “jumper connecting portion” of the invention, the “jumper wiring portion 25B” of this embodiment corresponds to an example of a “jumper wiring portion” of the invention, and the “jumper opening 43” of this embodiment corresponds to an example of a “jumper opening” of the invention.

Here, a space, which is defined by the jumper portion 25 and the upper surface of the lower base 21, is filled with an insulating material forming the lower insulating layer 40 and an insulating material forming the jumper portion-insulating layer 70. Accordingly, the straight portion 231 provided on the lower base 21 is covered with the lower insulating layer 40, and the inner peripheral side of the jumper portion 25 is covered with the jumper portion-insulating layer 70 and the low insulating layer 40.

The jumper portion-insulating layer 70 is formed by the application and curing of a resist material, such as an epoxy resin, a urethane resin, a polyester resin, or an acrylic resin, on the lower insulating layer 40. Meanwhile, in this embodiment, the adhesive layer 50 is also present at a position where the jumper portion-insulating layer 70 is formed and overlaps the jumper portion-insulating layer 70. However, an opening may be formed at the adhesive layer 50 to correspond to a position where the jumper portion-insulating layer 70 is formed so that the adhesive layer 50 and the jumper portion-insulating layer 70 do not overlap each other. The “jumper portion-insulating layer 70” of this embodiment corresponds to a “jumper portion-insulating portion” of the invention.

Since the upper insulating layer 30 is directly formed on the upper base 11 so as to cover the upper lead wires 13 in the membrane switch 1 according to this embodiment, the waterproof properties and the insulating properties of the upper lead wires 13 can be improved. Moreover, since the lower insulating layer 40 is directly formed on the lower base 21 so as to cover the lower lead wires 23 in the membrane switch 1 according to this embodiment, the waterproof properties and the insulating properties of the lower lead wires 23 can be improved. Further, since layers that are used to waterproof and insulate the upper and lower lead wires 13 and 23 and a spacer that is used to adjust an interval between the upper and lower electrodes 12 and 22 can be shared, effects of reducing the thickness of the membrane switch and reducing the number of steps in comparison with a case in which the layers and the spacer are separately formed, and the like can be obtained.

Since the jumper portions 25 formed at the lower base 21 are covered with the lower insulating layer 40, the jumper portion-insulating layers 70, and the upper insulating layer 30 in the membrane switch 1 according to this embodiment the waterproof properties and the insulating properties of the jumper portions 25 can be ensured. Here, since layers that are used to waterproof and insulate the jumper portions 25 and a spacer that is used to adjust an interval between the upper and lower electrodes 12 and 22 can be shared, effects of reducing the thickness of the membrane switch and reducing the number of steps in comparison with a case in which the layers and the spacer are separately formed, and the like can be obtained.

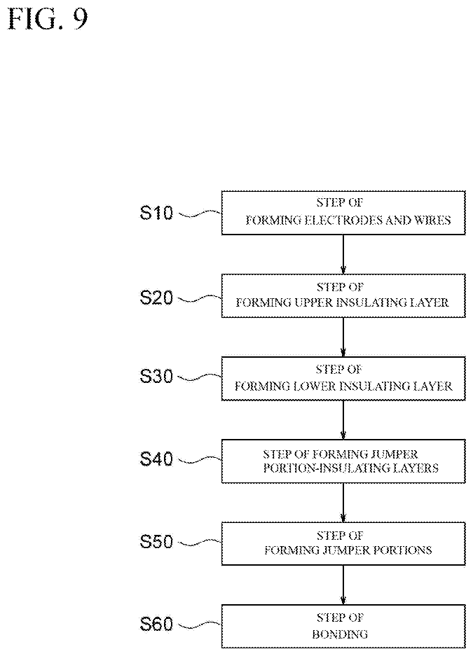

FIG. 9 is a flowchart illustrating a method for manufacturing the membrane switch 1 according to this embodiment. As illustrated in FIG. 9, the method for manufacturing the membrane switch 1 according to this embodiment includes a step (S10) of forming electrodes and wires, a step (S20) of forming an upper insulating layer, a step (S30) of forming a lower insulating layer, a step (S40) of forming jumper portion-insulating layers, a step (S50) of forming jumper portions, and a bonding step (S60).

In the step (S10) of forming electrodes and wires, the upper electrode 12 and the upper lead wires 13 are formed on the upper base 11. Further, the lower electrode 22 and the lower lead wires 23 are formed on the lower base 21. In this step, conductive paste, such as silver paste, copper paste, or carbon paste, is printed and cured on the lower surface 111 of the upper base 11 and the lower surface of the upper tail portion 14. Likewise, conductive paste, such as silver paste, copper paste, or carbon paste, is printed and cured on the upper surface 211 of the lower base 21 and the upper surface of the lower tail portion 24. Here, when the lower lead wires 23 are formed, the jumper portions 25 are not formed and the straight portions 232 are formed in a state in which each straight portion 232 is divided into the first straight portion 2321 and the second straight portion 2322 not so as to intersect the straight portion 231.

In the step (S20) of forming air upper insulating layer, the upper insulating layer 30 is formed on the lower surface 111 of the upper base 11. In this step, first, a resist material forming the upper insulating layer 30 is printed on the lower surface 111 of the upper base 11 by a printing method, such as screen printing, gravure offset printing, or inkjet printing. In this case, a layer, which includes the first opening 31 and is made of the resist material, is formed on the lower surface 111 of the upper base 11. Then, the layer, which is formed on the lower surface 111 of the upper base 11 and is made of the resist material, is cured. Here, in this embodiment, a UV curable resin is used as the resist material and UV curing treatment is performed as curing treatment. The control of the thickness of a layer to be cured in the UV curing treatment is easier than that in heat curing treatment. Accordingly, the accuracy of the thickness of the upper insulating layer 30 can be improved in this embodiment in comparison with a case in which a thermosetting resin is used as the resist material and heat curing treatment is performed to cure the resist material.

In the step (S30) of forming a lower insulating layer, the lower insulating layer 40 is formed on the upper surface 211 of the lower base 21. In this step, first, a resist material forming the lower insulating layer 40 is printed on the upper surface 211 of the lower base 21 by a printing method such as screen printing, gravure offset printing, or inkjet printing. In this case, a layer, which includes the second opening 41 and the jumper openings 43 and is made of the resist material, is formed on the upper surface 211 of the lower base 21. Then, the layer, which is formed on the upper surface 211 of the lower base 21 and is made of the resist material, is cured. Here, in this embodiment, a UV curable resin is used as the resist material and UV curing treatment is performed as curing treatment. The control of the thickness of a layer to be cured in the UV curing treatment is easier than that in heat curing treatment. Accordingly, the accuracy of the thickness of the upper insulating layer 40 can be improved in this embodiment in comparison with a case in which a thermosetting resin is used as the resist material and heat curing treatment is performed to cure the resist material.

In the step (S40) of forming jumper portion-insulating layers, the jumper portion-insulating layers 70 are formed on the lower insulating layer 40 at the positions where the jumper portions 25 are formed. In this step, a resist material, such as an epoxy resin, a urethane resin, a polyester resin, or an acrylic resin, is applied onto the lower insulating layer 40 and is cured.

In the step (S50) of forming jumper portions, the jumper portions 25 are formed on the lower electrode sheet 20. In this step, conductive paste, such as silver paste, copper paste, or carbon paste, is printed and cured on the lower insulating layer 40 and the jumper portion-insulating layers 70 so as to be filled in the jumper openings 43.

In the bonding step (S60), first, an adhesive material flaming the adhesive layer 50 is applied onto the upper insulating layer 30 or the lower insulating layer 40 by a publicly known method, such as gravure coating, roll coating, screen printing, gravure offset printing or inkjet printing. In this case a layer, which includes the third opening 51 and is made of the adhesive material, is formed on the upper insulating layer 30 or the lower insulating layer 40. Then, the adhesive material applied onto the upper insulating layer 30 or the lower insulating layer 40 is cured by drying or the like, so that the adhesive layer 50 is formed. Next, the lower surface of the upper insulating layer 30 and the upper surface of the lower insulating layer 40 are bonded to each other by laminating. Meanwhile, in this embodiment, the adhesive material is cured before the upper insulating layer 30 and the lower insulating layer are bonded to each other. However, the adhesive material may not be cured before the upper and lower insulating layers 30 and 40 are bonded to each other, and the adhesive material may be cured for the first time after the upper and lower insulating layers 30 and 40 are bonded to each other.

As described above, in the method for manufacturing the membrane switch 1 according to this embodiment, an insulating material forming the upper insulating layer 30 is printed on the lower surface 111 of the upper base 11 by the printing method and is cured. Further, an insulating material forming the lower insulating layer 40 is printed on the upper surface 211 of the lower base 21 by the printing method and is cured. Here, a printing technique is used when an insulating layer, which is made of an insulating material and includes an opening at the position corresponding to the upper and lower electrodes 12 and 22, is formed on the upper base 11 or the lower base 21. According to this printing technique, the diameters and positions of the openings can be set with high accuracy. Accordingly, the ON-load of the membrane switch 1 can be easily set with high accuracy.

Here, when the spacer 30B, which includes an opening at the position corresponding to the upper and lower electrodes 12 and 22, is formed and the spacer 30B is to be joined to the upper and lower bases 11 and 21 by the upper and lower adhesive layers 40B and 50B as in the above-mentioned comparative example (see FIGS. 3 and 4), high positioning accuracy of the spacer 30B and the upper and lower bases 11 and 21 is required in a joining step. In this case, high positioning accuracy of four elements, that is, the upper and lower bases 11 and 21 and the upper and lower insulating layers 30 and 40 is required. In contrast, in the method for manufacturing the membrane switch 1 of this embodiment, the upper insulating layer 30 is formed on the upper base 11 and the lower insulating layer 40 is formed on the lower base 21 after the diameters and positions of the first and second openings 31 and 41 are set with high accuracy by a printing technique. Accordingly, the positioning of two elements, that is, the upper electrode sheet 10 where the upper insulating layer 30 and the upper base 11 are integrated with each other with high positioning accuracy and the lower electrode sheet 20 where the lower insulating layer 40 and the lower base 21 are integrated with each other with high positioning accuracy suffices in a joining step. Accordingly, effects of simplifying steps and reducing man-hours in comparison with the above-mentioned comparative example, and the like can be obtained.

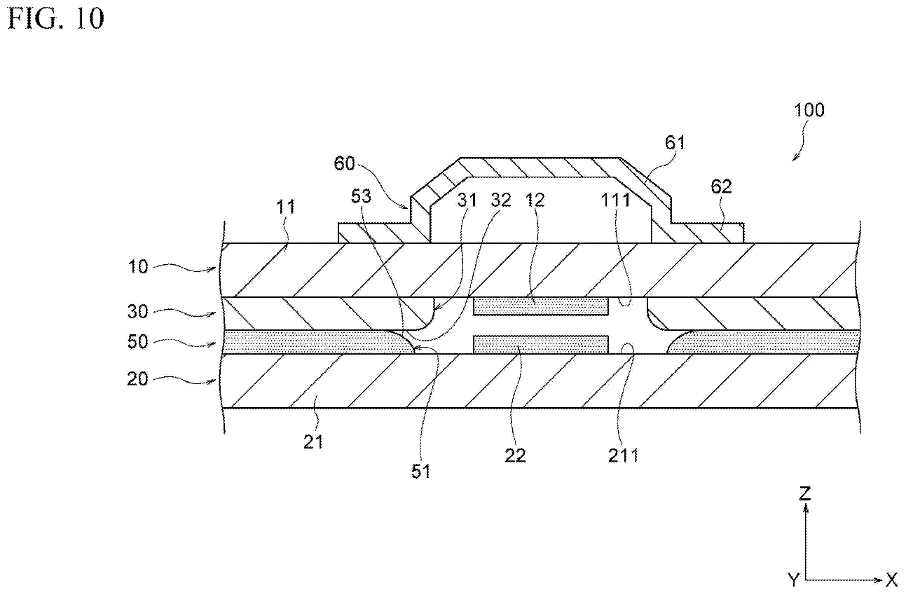

FIG. 10 is a cross-sectional view of a membrane switch 100 according to a second embodiment of the invention. Meanwhile, in the description of this embodiment, the same components as those of the first embodiment are denoted by the same reference numerals as those of the first embodiment and the description of the first embodiment will be quoted.

As illustrated in FIG. 10, the membrane switch 100 of this embodiment in an upper electrode sheet 10, a lower electrode sheet 20, an adhesive layer 50, and a rubber dome 50. The upper electrode sheet 10 includes an upper base 11, an upper electrode 12, and an upper insulating layer 30. In the membrane switch 100, the upper insulating layer 30 is formed on a lower surface 111 of the upper base 11 of the upper electrode sheet 10, and an upper surface 211 of a lower base 21 of the lower electrode sheet 20 and the lower surface of the upper insulating layer 30 adhere to each other by the adhesive layer 50.

Here, the lower electrode sheet 20 is firmly fixed to a device, such as a keyboard device on which the membrane switch 100 is to be mounted. For this reason, an insulating layer, which is used for reinforcement, is not formed on the lower electrode sheet 20.

Here, even in the membrane switch 100 of this embodiment, the upper insulating layer 30 is formed on the lower surface 111 of the upper base 11 and the upper base 11 and the upper insulating layer 30 are integrated with each other. Accordingly, the upper base 11 is reinforced by the upper insulating layer 30. Further, the stiffness of an integrated object in which the upper base 11 and the upper insulating layer 30 are integrated with each other is set so that the restoring force of the upper base 11 and the upper insulating layer 30 generated from an elastically deformed state exceeds the adhesive force of the adhesive layer 50. For this reason, the upper base 11 and the upper insulating layer 30 are restored from an elastically deformed state, that is, a recessed state after an operation for pressing the membrane switch 100. Accordingly, since it is possible to prevent a state in which the upper base 11 is bonded along the shape of the edge portion 53 of the adhesive layer 50, that is, a state in which the upper base 11 is recessed from being maintained after an operation for pressing the membrane switch 1, it is possible to prevent an ON state from being maintained.

Furthermore, in the membrane switch 100 of this embodiment, only the upper electrode sheet 10 to which a pressing force is to be applied is reinforced by the upper insulating layer 30, and the lower electrode sheet 20 is firmly fixed to a device, such as a keyboard device. Accordingly, the membrane switch 100 can be made thinner than the membrane switch 1 of the first embodiment that includes the upper and lower insulating layers 30 and 40.

Here, the total thickness of the upper insulating layer 30 and the adhesive layer 50 is set to be smaller than the thickness of the upper base 11 or the lower base 21. Accordingly, it is possible to reduce the thickness of the membrane switch 100 and to suppress a recess that is to be formed at the contact portion of the upper electrode sheet 10 or the lower electrode sheet 20. The “membrane switch 100” of this embodiment corresponds to an example of a “switch” of the invention, and the “upper insulating layer 30” of this embodiment corresponds to an example of a “first spacer” of the invention.

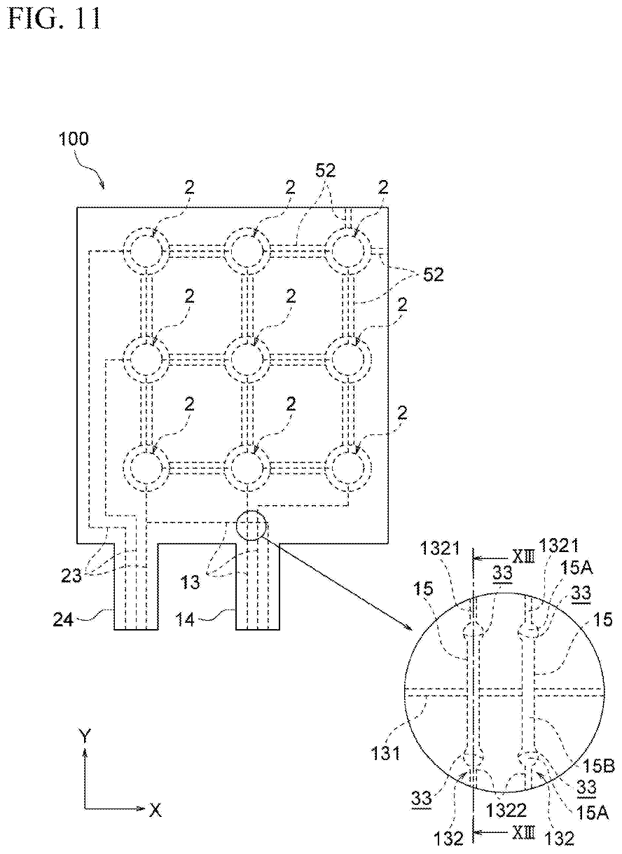

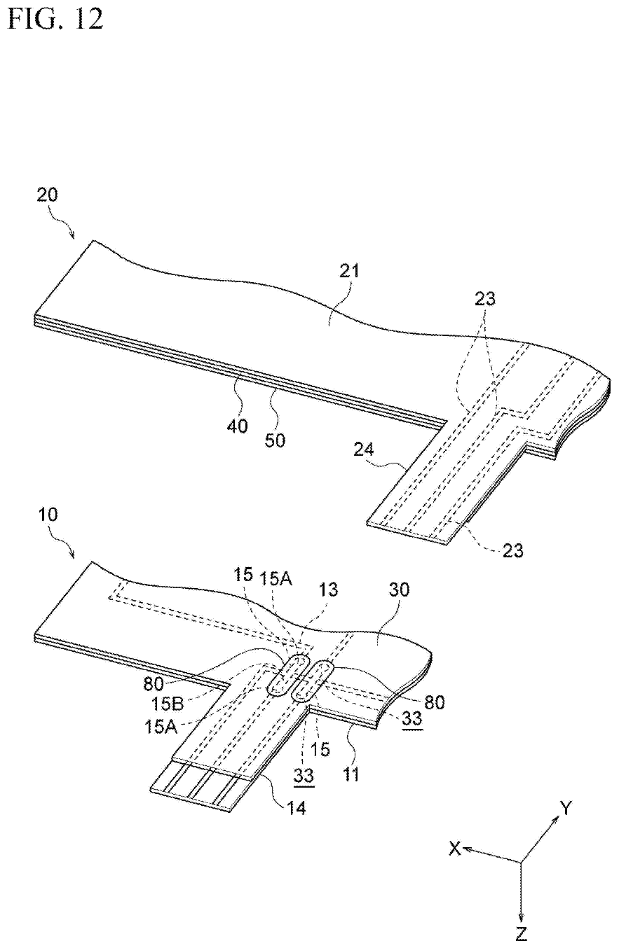

FIG. 11 is a plan view of the membrane switch 100 according to this embodiment. Further, FIG. 12 is an exploded perspective view of the membrane switch 100 according to this embodiment. Meanwhile, the membrane switch 100 of FIG. 11 is vertically inverted in FIG. 12. As illustrated in FIGS. 11 and 12, the membrane switch 100 includes a plurality of electrode pairs 2, each of which includes the upper electrode 12 and the lower electrode 22. Furthermore, the membrane switch 100 includes a plurality of upper lead wires 13 that are provided on the upper base 11 of the upper electrode sheet 10, a plurality of lead wires 23 that are provided on the lower base 21 of the lower electrode sheet 20, an upper tail portion 14 that is provided on one side of the upper base 11 and a lower tail Portion 24 that is provided on one side of the lower base 21.

The lower lead wires 21 are connected to the plurality of lower electrodes 22 arranged in a line, and are provided so as to extend to the end of the lower tail portion 24. The plurality of lead wires 23 are provided not to intersect each other. For this reason, the lead wires 23 do not include jumper portions. Meanwhile, the upper lead wires 13 are connected to the plurality of upper electrodes 12 arranged in a line, and are provided so as to extend to the end of the upper tail portion 14. Here, the plurality of lead wires 13 are provided so that two lead wires 13 intersect another lead wire 13. For this reason, jumper portions 15 are provided at two intersections where two lead wires 13 intersect another lead wire 13. The detailed structure of the jumper portion 15 will be described later. Meanwhile, “another lead wire 13” corresponds to an example of a “first lead wire” of the invention and “two lead wires 13” correspond to an example of a “second lead wire” of the invention.

The upper insulating layer 30 is directly and integrally formed on the upper base 11, and is formed so as to cover the upper lead wires 13. In this embodiment, the lead wires 13 provided on the upper base 11 are covered with the upper insulating layer 30 except for a position facing the first opening 31. Meanwhile, the lead wires 13 provided on the upper tail portion 14 may be covered with the upper insulating layer 30, and may be covered with another insulating layer that is formed on the lower tail portion 24 separately from the upper insulating layer 30. Further, it is not essential that the lead wires 13 provided on the upper base 11 are covered with the upper insulating layer 30 over the entire area of the upper base 11, and a part of the lead wires 13 provided on the upper base 11 may be covered with another insulating material.

On the other hand, an insulating layer, which covers the lead wires 23, is not formed on the lower base 21. The lead wires 23, which are formed on the upper surface 211 of the lower base 21, are covered with the adhesive layer 50 and the upper insulating layer 30 except for positions facing a second opening 41 and a third opening 51. Meanwhile, the lead wires 23 provided on the lower tail portion 24 are covered with an insulating material that is formed on the lower tail portion 24.

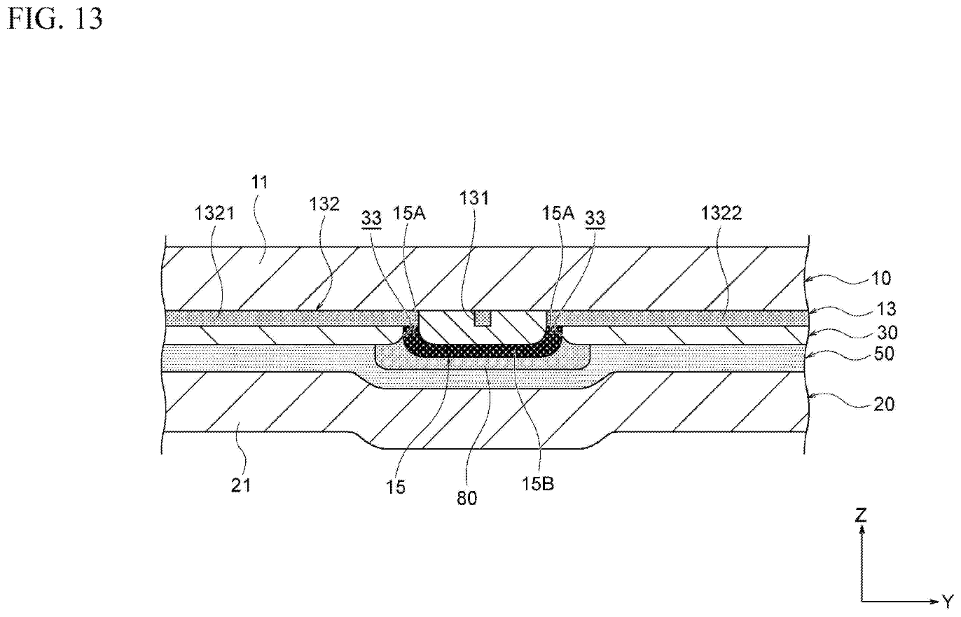

FIG. 13 is a cross-sectional view taken along line XIII-XIII of a partially enlarged view of FIG. 11. As illustrated in FIGS. 11 to 13, one lead wire 13 includes a straight portion 131 extending along one side of the upper base 11, and the other two lead wires 13 include straight portions 132 intersecting the straight portion 131. The straight portion 132 is divided into a first straight portion 1321 and a second straight portion 1322 not so as to intersect the straight portion 231 on the upper base 11. An end portion of the first straight portion 1321 and an end portion of the second straight portion 1322 are connected to each other by the jumper portion 25.

The upper insulating layer 30 includes jumper openings 33 that are formed at positions facing the end portions of the first and second straight portions 1321 and 1322, respectively. A part of the first and second straight portions 1321 and 1322 overlap the jumper openings 33 and are exposed from the lower insulating layer 40. The jumper portion 15 is formed so as to straddle the straight portion 131 provided on the upper base 11, and includes a pair of jumper connecting portions 15A and a jumper wiring portion 15B that connects the pair of jumper connecting portions 15A. The respective jumper connecting portions 15E are tilled in the jumper openings 33, and are connected to the end portion of the first straight portion 1321 or the end portion of the second straight portion 1322. Further, the jumper wiring portion 15B is formed on the upper insulating layer 30. The “jumper portion 15” of this embodiment corresponds to an example of a “jumper portion” of the invention, the “jumper connecting portion 15A” of this embodiment corresponds to an example of a “jumper connecting portion” of the invention, the “jumper wiring portion 15B” of this embodiment corresponds to an example of a “jumper wiring portion” of the invention, and the “jumper opening 33” of this embodiment corresponds to an example of a “jumper opening” of the invention.

Here, a space, which is defined by the jumper portion 15 and the lower surface of the upper base 11, is filled with an insulating material forming the upper insulating layer 30. Accordingly, the straight portion 131 provided on the upper base 11 is covered with the upper insulating layer 30, and the inner peripheral side of the jumper portion 15 is covered with the upper insulating layer 30.

Jumper portion-insulating layers 80 are formed on the upper insulating layer 30 so as to cover the jumper wiring portions 15B. The jumper portion-insulating layers 80 are formed only at positions where the jumper portions 15 are provided. Further, a resist material, such as an epoxy resin, a urethane resin, a polyester resin, or an acrylic resin, is applied onto the upper insulating layer 30 so as to cover the jumper portion 15 and is cured, so that the jumper portion-insulating layer 80 is formed. Meanwhile, in this embodiment, the adhesive layer 50 is also present at a position where the jumper portion-insulating layer 80 is formed and overlaps the jumper portion-insulating layer 80. However, an opening may be formed at the adhesive layer 5.0 to correspond to a position where the jumper portion-insulating layer 80 is formed so that the adhesive layer 50 and the jumper portion-insulating layer 80 do not overlap each other. The “jumper portion-insulating layer 80” of this embodiment corresponds to a “jumper portion-insulating portion” of the invention.

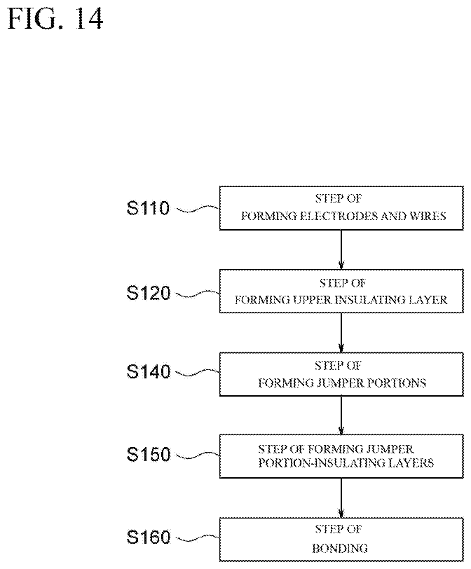

FIG. 14 is a flowchart illustrating a method for manufacturing the membrane switch 100 according to this embodiment. As illustrated in FIG. 14, the method for manufacturing the membrane switch 100 according to this embodiment includes a step (S110) of forming electrodes and wires, a step (S120) of forming an upper insulating layer, a step (S140) of forming jumper portions, a step (S150) of forming jumper portion-insulating layers, and a bonding step (S160).

In the step (S110) of forming electrodes and wires, the upper electrode 12 and the upper lead wires 13 are formed on the upper base 11. Further, the lower electrode 22 and the lower lead wires 23 are formed on the lower base 21. In this step, conductive paste, such as silver paste, copper paste, or carbon paste, is printed and cured on the lower surface 111 of the upper base 11 and the lower surface of the upper tail portion 14. Likewise, conductive paste, such as silver paste, copper paste, or carbon paste, is printed and cured on the upper surface 211 of the lower base 21 and the upper surface of the lower tail portion 24. Here, when the upper lead wires 13 are formed, the jumper portions 15 are not formed and the straight portions 132 are formed in a state in which each straight portion 132 is divided into the first straight portion 1321 and the second straight portion 1322 not so as to intersect the straight portion 231.

In the step (S120) of forming an upper insulating layer, the upper insulating layer 30 is formed on the lower surface 111 of the upper base 11. In this step, first, a resist material forming the upper insulating layer 30 is printed oaf the lower surface 111 of the upper base 11 by a printing method, such as screen printing, gravure offset printing, or inkjet printing. In this case, a layer, which includes the first opening 31 and the jumper openings 33 and is made of the resist material, is formed on the lower surface 111 of the upper base 11. Then, the layer, which is formed on the lower surface 111 of the upper base 11 and is made of the resist material, is cured. Here, in this embodiment, a UV curable resin is used as the resist material and UV curing treatment is performed as curing treatment. The control of the thickness of a layer to be cured in the UV curing treatment is easier than that in heat curing treatment. Accordingly, the accuracy of the thickness of the upper insulating layer 30 can be improved in this embodiment in comparison with a case in which a thermosetting resin is used as the resist material and heat curing treatment is performed to cure the resist material.

In the step (S140) of forming jumper portions, the jumper portions 15 are formed on the upper electrode sheet 10. In this step, conductive paste, such as silver paste, copper paste, or carbon paste, is printed and cured on the upper insulating layer 30 so as to be filled in the jumper openings 33.

In the step (S150) of forming jumper portion-insulating layers, the jumper portion-insulating layers 80 are formed on the upper insulating layer 30 at the positions where the jumper portions 15 are formed. In this step, a resist material, such as an epoxy resin, a urethane resin, a polyester resin, or an acrylic resin, is applied onto the upper insulating layer 30 and the jumper portions 15 and is cured.

In the bonding step (S160), first, an adhesive material forming the adhesive layer 50 is applied onto the upper insulating layer 30 or the lower base 21 by a publicly known method, such as gravure coating, roll coating, screen printing, gravure offset printing, or inkjet printing. In this case, a layer, which includes the third opening 51 and is made of the adhesive material, is formed on the upper insulating layer 30 or the lower base 21. Then, the adhesive material applied onto the upper insulating layer 30 or the lower base 21 is cured by drying or the like, so that the adhesive layer 50 is formed. Next, the lower surface of the upper insulating layer 30 and the upper surface 211 of the lower base 21 are bonded to each other by laminating. Meanwhile, in this embodiment, the adhesive material is cured before the upper insulating layer 30 and the lower base 21 are bonded to each other. However, the adhesive material may not be cured before the upper insulating layer 30 and the lower base 21 are bonded to each other, and the adhesive material may be cured for the first time after the upper insulating layer 30 and the lower base 21 are bonded to each other.

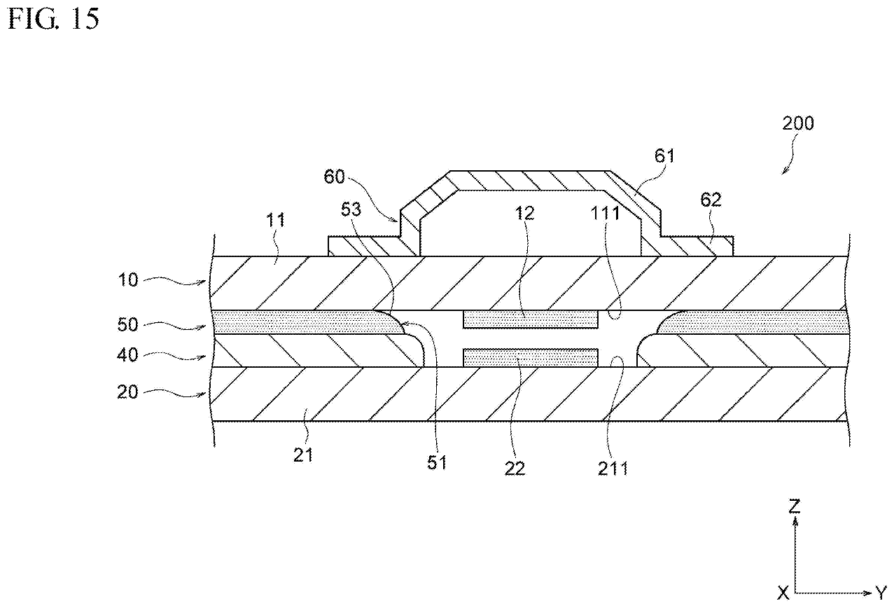

FIG. 15 is a cross-sectional view of a membrane switch 200 according to a third embodiment of the invention. Meanwhile, in the description of this embodiment, the same components as those of the first and second embodiments are denoted by the same reference numerals as those of the first and second embodiments and the description of the first and second embodiments will be quoted.

As illustrated in FIG. 15, the membrane switch 200 of this embodiment includes an upper electrode sheet 10, a lower electrode sheet 20 an adhesive layer 50, and a rubber dome 50. The lower electrode sheet 20 includes a lower base 21, a lower electrode 22, and a lower insulating layer 40. In the membrane switch 200, the lower insulating layer 40 is formed on an upper surface 211 of the lower base 21 of the lower electrode sheet 20, and a lower surface 111 of an upper base 11 of the upper electrode sheet 10 and the upper surface of the lower insulating layer 40 adhere to each other by the adhesive layer 50.

That is, in the membrane switch 200 according to this embodiment the lower insulating layer 40 is formed around the lower electrode 22 provided on the upper surface 211 of the lower base 21 and the lower base 21 and the lower insulating layer 40 are integrated with each other around the lower electrode 22, so that the lower base 21 is reinforced by the lower insulating layer 40. Accordingly, even though the lower base 21 is not firmly fixed to a device, such as a keyboard device on which the membrane switch 200 is to be mounted, it is difficult for a portion where the lower base 21 and the lower insulating layer 40 are integrated with each other to be bent when a pressing force is applied to the upper base 11 through the rubber dome 60. For this reason, even though an edge portion 32 of the upper insulating layer 30 comes into contact with an edge portion 53 of the adhesive layer 50 due to an excessive pressing force that is applied to the upper base 11 through the rubber dome 60, the upper base 11 and the upper insulating layer 30 are easily restored from an elastically deformed state, that is, a recessed state. Accordingly, since it is possible to prevent a state in which the upper base 11 is bonded along the shape of the edge portion 53 of the adhesive layer 50, that is, a state in which the upper electrode sheet 10 is recessed from being maintained after an operation for pressing the membrane switch 200, it is possible to prevent an ON state from being maintained.

Here, the total thickness of the lower insulating layer 40 and the adhesive layer 50 is set to be smaller than the thickness of the upper base 11 or the lower base 21. Accordingly, it is possible to reduce the thickness of the membrane switch 200 and to suppress a recess that is to be formed at the contact portion of the upper electrode sheet 10 or the lower electrode sheet 20.

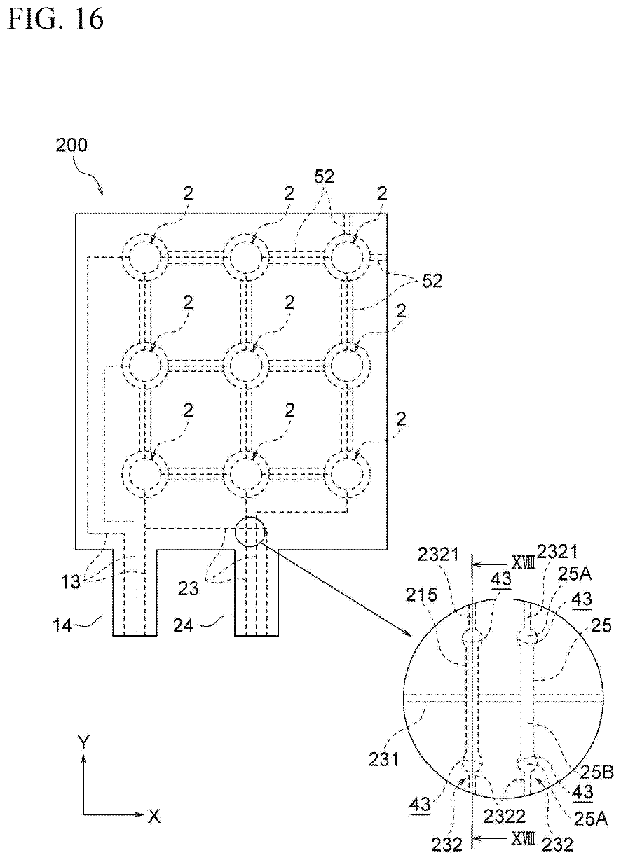

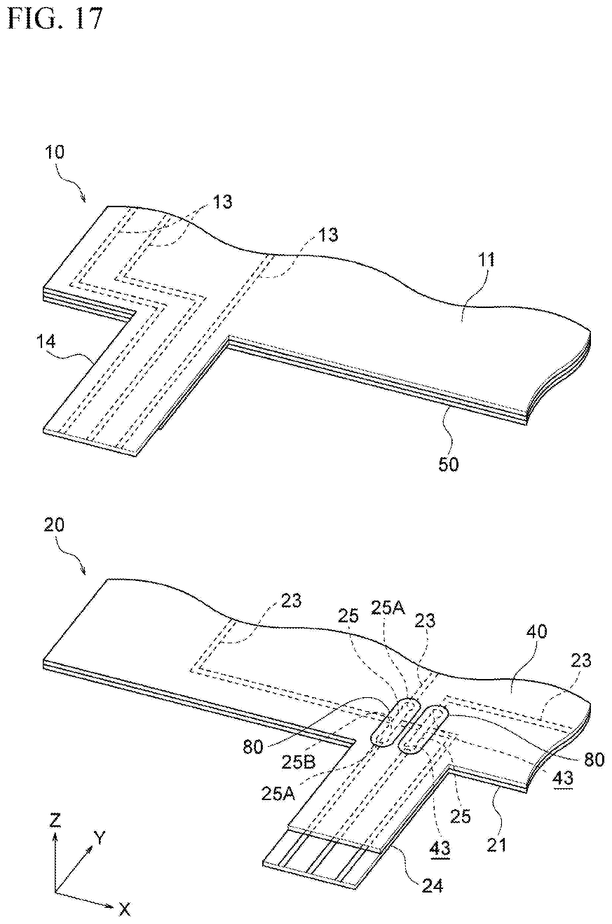

FIG. 16 is a plan view of the membrane switch 200 according to this embodiment. Further, FIG. 17 is an exploded perspective view of the membrane switch 200 according to this embodiment. As illustrated in FIGS. 16 and 17, upper lead wires 13 are connected to a plurality of upper electrodes 12 arranged in a line, and are provided so as to extend to the end of an upper tail portion 14. The plurality of lead wires 13 are provided not to intersect each other. For this reason, the lead wires 13 do not include jumper portions. Meanwhile, lower lead wires 23 are connected to a plurality of lower electrodes 22 arranged in a line, and are provided so as to extend to the end of a lower tail portion 24. Here, the plurality of lead wires 23 are provided so that two lead wires 23 intersect another lead wire 13. For this reason, jumper portions 25 are provided at two intersections where two lead wires 23 intersect another lead wire 23. The detailed structure of the jumper portion 25 will be described later. “Another lead wire 23” corresponds to an example of a “first lead wire” of the invention and “two lead wires 23” correspond to an example of a “second lead wire” of the invention.

The upper lead wires 13 are formed by the printing and curing of conductive paste, such as silver paste, copper paste, or carbon paste, on the lower surface 111 of the upper base 11 and the lower surface of the upper tail portion 14. Likewise, the lower lead wires 23 are formed by the printing and curing of conductive paste, such as silver paste, copper paste, or carbon paste, on the upper surface 211 of the lower base 21 and the upper surface of the lower tail portion 24.

The lower insulating layer 40 is directly and integrally formed on the lower base 21, and is formed so as to cover the lower lead wires 23. In this embodiment, the lead wires 23 provided on the lower base 21 are covered with the lower insulating layer 40 except for a position facing the second opening 41. Meanwhile, the lead wires 23 provided on the lower tail portion 24 may be covered with the lower insulating layer 40, and may be covered with another insulating layer that is formed on the lower tail portion 24 separately from the lower insulating layer 40. Further, it is not essential that the lead wires 23 provided on the lower base 21 are covered with the lower insulating layer 40 over the entire area of the lower base 21, and a part of the lead wires 23 provided on the lower base 21 may be covered with another insulating material.

On the other hand, an insulating layer, which covers the lead wires 13, is not formed on the upper base 11. The lead wires 13, which are formed on the lower surface 111 of the upper base 11, are covered with the adhesive layer 50 and the lower insulating layer 40 except for positions facing a first opening 31 and a third opening 51. Meanwhile, the lead wires 13 provided on the upper tail portion 14 are covered with an insulating material that is formed on the upper tail portion 14.

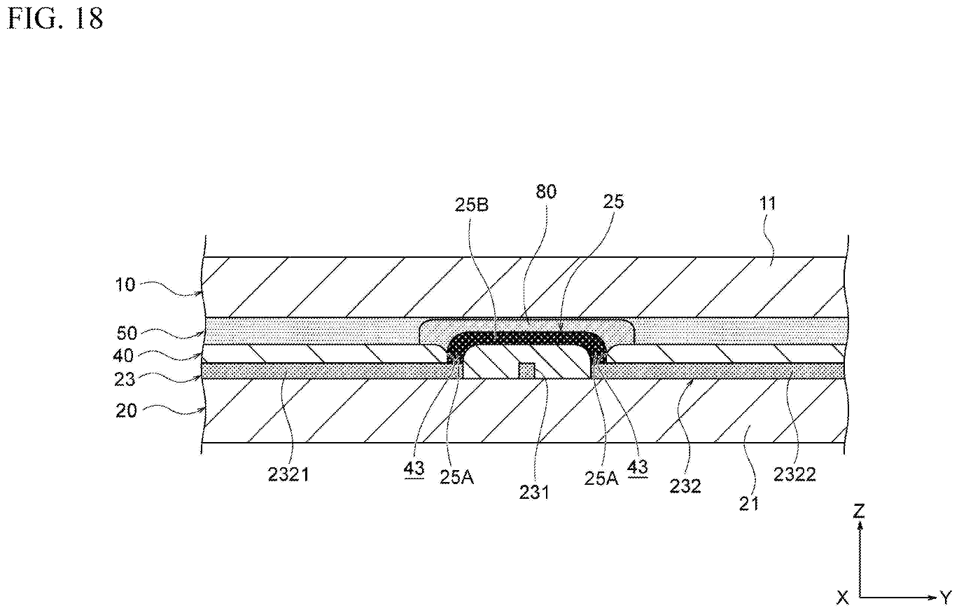

FIG. 18 is a cross-sectional view taken along line XVIII-XVIII of a partially enlarged view of FIG. 16. As illustrated in FIGS. 16 to 18, one lead wire 23 includes a straight portion 231 extending along one side of the lower base 21, and the other two lead wires 23 include straight portions 232 intersecting the straight portion 231. The straight portion 232 is divided into a first straight portion 2321 and a second straight portion 2322 not so as to intersect the straight portion 231 on the lower base 21. An end portion of the first straight portion 2321 and an end portion of the second straight portion 2322 are connected to each other by the jumper portion 25.

The lower insulating layer 40 includes jumper openings 43 that are respectively formed at positions facing the end portions of the first and second straight portions 2321 and 2322. A part of the first and second straight portions 2321 and 2322 overlap the jumper openings 43 and are exposed from the lower insulating layer 40. The jumper portion 25 is formed so as to straddle the straight portion 231 provided on the lower base 21, and includes a pair of jumper connecting portions 25A and a jumper wiring portion 25B that connects the pair of jumper connecting portions 25A. The respective jumper connecting portions 25A are filled in the jumper openings 43, and are connected to the end portion of the first straight portion 2321 or the end portion of the second straight portion 2322. Further, the jumper wiring portion 25B is formed on the lower insulating layer 40.

Here, a space, which is defined by the jumper portion 25 and the upper surface of the lower base 21, is filled with an insulating material forming the lower insulating layer 40. Accordingly, the straight portion 231 provided on the lower base 21 is covered with the lower insulating layer 40, and the inner peripheral side of the jumper portion 25 is covered with the lower insulating layer 40.

Jumper portion-insulating layers 80 are formed on the lower insulating layer 40 so as to cover the jumper wiring portions 25B. The jumper portion-insulating layers 80 are formed only at positions where the jumper portions 25 are provided. Further, the jumper portion-insulating layer 80 is formed by the application and curing of a resist material, such as an epoxy resin, a urethane resin, a polyester resin, or an acrylic resin, on the lower insulating layer 40. Here, in this embodiment, an opening is formed at the adhesive layer 50 to correspond to a position where the jumper portion-insulating layer 80 is formed so that the adhesive layer 50 and the jumper portion-insulating layer 80 do not overlap each other. Accordingly, the upper base 11 is made flat even at the positions where the upper base 11 overlaps the jumper portion-insulating layers 80.

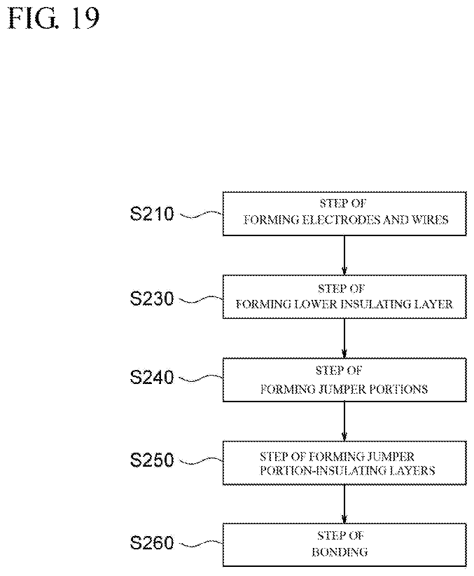

FIG. 19 is a flowchart illustrating a method for manufacturing the membrane switch 200 according to this embodiment. As illustrated in FIG. 19, the method for manufacturing the membrane switch 200 according to this embodiment includes a step (S210) of forming electrodes and wires, a step (S230) of forming a lower insulating layer, a step (S240) of forming jumper portions, a step (S250) of forming jumper portion-insulating layers, and a bonding step (S760).

In the step (S210) of forming electrodes and wires, the upper electrode 12 and the upper lead wires 13 are formed on the upper base 11. Further, the lower electrode 22 and the lower lead wires 23 are formed on the lower base 21. In this step, conductive paste, such as silver paste, copper paste, or carbon paste, is printed and cured on the lower surface 111 of the upper base 11 and the lower surface of the upper tail portion 14. Likewise, conductive paste, such as silver paste, copper paste, or carbon paste, is printed and cured on the upper surface 211 of the lower base 21 and the upper surface of the lower tail portion 24. Here, when the lower lead wires 23 are formed, the jumper portions 25 are not formed and the straight portions 232 are formed in a state in which each straight portion 232 is divided into the first straight portion 2321 and the second straight portion 2372 not so as to intersect the straight portion 231.

In the step (S230) of forming a lower insulating layer, the lower insulating layer 40 is formed on the upper surface 211 of the lower base 21. In this step, first, a resist material forming the lower insulating layer 40 is printed on the upper surface 211 of the lower base 21 by a printing method, such as screen printing, gravure offset printing, or inkjet printing. In this case, a layer, which includes the second opening, 41 and the jumper openings 43 and is made of the resist material, is formed on the upper surface 211 of the lower base 21. Then, the layer, which is formed on the upper surface 211 of the lower base 21 and is made of the resist material, is cured. Here, in this embodiment, a UV curable resin is used as the resist material and UV curing treatment is performed as curing treatment. The control of the thickness of a layer to be cured in the UV curing treatment is easier than that in heat curing treatment. Accordingly, the accuracy of the thickness of the upper insulating layer 30 can be improved in this embodiment in comparison with a case in which a thermosetting resin is used as the resist material and heat curing treatment is performed to cure the resist material.

In the step (S240) of forming jumper portions, the jumper portions 25 are formed on the lower electrode sheet 20. In this step, conductive paste, such as silver paste, copper paste, or carbon paste, is printed and cured on the lower insulating layer 40 so as to be filled in the jumper openings 43.

In the step (S250) of forming jumper portion-insulating layers, the jumper portion-insulating layers 80 are formed on the lower insulating layer 40 at the positions where the jumper portions 25 are formed. In this step, a resist material, such as an epoxy resin, a urethane resin, a polyester resin, or an acrylic resin, is applied onto the lower insulating layer 40 and the jumper portions 25 and is cured.

In the bonding step (S260), first, an adhesive material forming the adhesive layer 50 is applied onto the lower insulating layer 40 or the upper base 11 by a publicly known method, such as gravure coating, roll coating, screen printing, gravure offset printing, or inkjet printing. In this case, a layer, which includes the third opening 51 and is made of the adhesive material, is formed on the lower insulating layer 40 or the upper base 11. Then, the adhesive material applied onto the lower insulating layer 40 or the upper base 11 is cured by drying or the like, so that the adhesive layer 50 is formed. Next, the upper surface of the lower insulating layer 40 and the lower surface 111 of the upper base 11 are bonded to each other by laminating. Meanwhile, in this embodiment, the adhesive material is cured before the lower insulating layer 40 and the upper base 11 are bonded to each other. However, the adhesive material may not be cured before the lower insulating layer 40 and the upper base 11 are bonded to each other, and the adhesive material may be cured for the first time after the lower insulating layer 40 and the upper base 11 are bonded to each other.

The above-mentioned embodiments are described to facilitate the understanding of the invention, and are not described to limit the invention. Accordingly, the respective elements disclosed iii the embodiments are to also include all design changes or equivalents belonging to the scope of the invention.

For example, the adhesive layer 50, which includes the third opening 51 and of which an adhesive spreads in a planar shape, is formed in the above-mentioned embodiments, but an adhesive layer on which a plurality of spot-like adhesives are arranged around the first and second openings 31 and 41 may be formed.

Further, an adhesive is provided outside the peripheral edge portions of the first and second openings 31 and 41 in the above-mentioned embodiments, but the adhesive may be provided so that the edge portion of the adhesive coincides with the positions of the peripheral edge portions of the first and second openings 31 and 41.

Furthermore, an example of a structure in which the upper and lower electrodes 12 and 22 come into contact with each other due to a pressing force applied to the upper electrode sheet 10 and conduct electricity has been described in the above-mentioned embodiments. However, the upper and lower electrodes 12 and 22 may be adapted to come into contact with each other due to a pressing force applied to the lower electrode 20 and to conduct electricity, or the upper and lower electrodes 12 and 22 may be adapted to conic into contact with each other due to pressing forces applied to the upper and lower electrodes 10 and 20 and to conduct electricity

### EXPLANATIONS OF LETTERS OR NUMERALS

1, 100, 200: membrane switch
10: upper electrode sheet
11: upper base
111: lower surface
12: upper electrode
13: lead wire
131: straight portion
132: straight portion
1321: first straight portion
1322: second straight portion
14: tail portion
15: jumper portion
15A: jumper connecting portion
15B: jumper wiring portion
20: lower electrode sheet
21: lower base
211: upper surface
22: lower electrode
23: lead wire
231: straight portion
232: straight portion
2321: first straight portion
2322: second straight portion
24: tail portion
25: jumper portion
25A: jumper connecting portion
25B: jumper wiring portion
30: upper insulating layer
31: first opening
32: edge portion
33: jumper opening
40: lower insulating layer
41: second opening
42: edge portion
43: jumper opening
50: adhesive layer
51: third opening
52: air vent
53: edge portion
60: rubber dome
61: body portion
62: mounting portion
70: jumper portion-insulating layer
80: jumper portion-insulating layer
S: interior space
1B: membrane switch
30B: spacer
31B: first opening
40B: upper adhesive layer
41B: second opening
43B: edge portion
50B: lower adhesive layer
51B: third opening

1. A switch comprising:
a first electrode sheet that includes a first electrode;
a second electrode sheet that includes a second electrode facing the first electrode; and
an adhesive material that joins the first electrode sheet to the second electrode sheet,
wherein the first and second electrodes conic into contact with each other and conduct electricity due to a pressing force, which is applied to at least one of the first and second electrode sheets, and
the first electrode sheet includes:
a first base on which the first electrode is formed; and
a first spacer that is provided between the first base and the second electrode sheet, includes a first opening at a position corresponding to the first electrode, and is joined to the second electrode sheet by the adhesive material, and
the first spacer is formed on the first base.

2. The switch according to claim 1,
wherein the second electrode sheet includes:
a second base on which the second electrode is formed; and
a second spacer that is provided between the second base and the first spacer, includes a second opening at a position corresponding to the second electrode, and is joined to the first spacer by the adhesive material, and
the second spacer is formed on the second electrode sheet.

3. The switch according to claim 1,
wherein the second electrode sheet includes a second base on which the second electrode is formed, and
the first spacer is joined to the second base by the adhesive material.

4. The switch according to claim 1, wherein the adhesive material is positioned outside a peripheral edge of the first opening.

5. The switch according to claim 1, wherein the stiffness of the first spacer is higher than the stiffness of the adhesive material.

6. The switch according to claim 1, wherein the first spacer is thinner than the first base.

7. The switch according to claim 1, wherein the first electrode sheet includes lead wires formed on the first base, and the first spacer includes an insulating cover portion that covers the lead wires.

8. The switch according to claim 7,
wherein the lead wires include:
a first lead wire, and
a second lead wire that includes a jumper portion at a position intersecting the first lead wire,
wherein the cover portion includes jumper openings formed at the cover portion so as to overlap a part of the second lead wire formed on the first base, and is interposed between the jumper portion and the first lead wire intersecting each other, and
the jumper portion includes:
a pair of jumper connecting portions that is filled in the jumper openings and is connected to the second lead wire formed on the first base; and
a jumper wire that is formed on the cover portion and connects the pair of jumper connecting portions.

9. The switch according to claim 8, further comprising
an insulating jumper portion-insulating portion that is formed on the cover portion so as to cover the jumper portion.

10. A method for manufacturing a switch, the switch including:
a first electrode sheet that includes a first electrode,
a second electrode sheet that includes a second electrode facing the first electrode, and
an adhesive material that joins the first electrode sheet to the second electrode sheet, the first and second electrodes coming into contact with each other and conducting electricity due to a pressing force, which is applied to the first electrode sheet or the second electrode sheet,
wherein the method comprising:
forming a first spacer, which includes an opening at a position corresponding to the first electrode, on a first base on which the first electrode is formed: and
joining the first spacer to the second electrode sheet by the adhesive material.

11. The method for manufacturing a switch according to claim 10,
wherein the first spacer is formed by the printing and curing of an insulating material, which forms the first spacer, on the first base.
